(19) United States
(12) Patent Application Publication
(10) Pub. No.: US 2026/0289113 A1
(43) Pub. Date: Sep. 24, 2026

(54) SYSTEM

(71) Applicant: SoftBank Group Corp., Tokyo (JP)

(72) Inventor: Shingo HAYAKAWA, Tokyo (JP)

(73) Assignee: SoftBank Group Corp., Tokyo (JP)

(21) Appl. No.: 19/562,804

(22) Filed: Mar. 11, 2026

(30) Foreign Application Priority Data
Mar. 19, 2025 (JP) 2025-044923

(51) Int. Cl. G06F 40/253; G06N 3/0475

(52) U.S. Cl. CPC G06F 40/253; G06N 3/0475

(57) ABSTRACT

A system includes a processor that is configured to: tokenize a text input by a user and detect typographical errors and omissions in the text; generate a prompt sentence that instructs a generative artificial intelligence model to correct the typographical errors and omissions, and obtain a correction proposal from the generative artificial intelligence model based on the prompt sentence; and generate a prompt sentence that instructs the generative artificial intelligence model to create a rewrite proposal for improving politeness of the text.

### CROSS-REFERENCE TO RELATED APPLICATION

This application is based on and claims priority under 35 USC 119 from Japanese Patent Application No. 2025-044923 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, electronic communication via email, messaging applications, and web-based tools has rapidly increased in both personal and business contexts. However, conventional text input support systems mainly focus on simple spellchecking and limited grammar correction, and do not sufficiently address multiple practical problems faced by users. For example, when a user composes a message, typographical errors and omissions may remain undetected, and the tone of the message may be overly casual or impolite, which can cause misunderstanding or deterioration of business relationships. Existing systems generally do not utilize generative artificial intelligence models in a structured manner to simultaneously correct such errors and improve politeness, while preserving the original intent of the text.

Furthermore, when a recipient reads a message, it often requires time and effort to manually grasp the main point, deadline, and stakeholders from long or complex sentences. Conventional mailbox or messaging applications may provide keyword search or basic highlighting functions, but they do not automatically analyze the content at a semantic level to extract and present key information in a concise and structured form. As a result, important information such as deadlines and involved persons may be overlooked, leading to missed tasks or delays.

Accordingly, there is a need for a system that can: (i) assist a user during composition by automatically detecting typographical errors and omissions and generating corrections and politeness-improving rewrite proposals using a generative artificial intelligence model, and (ii) assist a recipient by analyzing received text to extract at least the main point, a deadline, and stakeholders, and cause such extracted information to be displayed on a terminal. The present invention has been made in view of these problems, and an object of the invention is to provide a system that improves both the quality and efficiency of text-based communication by leveraging a processor that cooperates with a generative artificial intelligence model.

### SUMMARY

In order to achieve the above-described object, a system according to one aspect of the present invention comprises a processor, wherein the processor is configured to tokenize a text input by a user and detect typographical errors and omissions in the text. By performing tokenization and error detection, the processor can identify positions and types of potential mistakes in the text at a fine-grained level. The processor is further configured to generate a prompt sentence that instructs a generative artificial intelligence model to correct the typographical errors and omissions, and obtain a correction proposal from the generative artificial intelligence model based on the prompt sentence. By doing so, the system uses the generative artificial intelligence model in a controlled manner to create context-aware correction proposals rather than merely performing rule-based spellchecking.

The processor is also configured to generate a prompt sentence that instructs the generative artificial intelligence model to create a rewrite proposal for improving politeness of the text. In response to this prompt sentence, the generative artificial intelligence model generates a rewritten version of the text that maintains the original meaning while adjusting tone, honorific expressions, and other stylistic aspects appropriate for the intended communication context. The processor can present the correction proposal and the politeness-improving rewrite proposal to the user via a terminal, thereby enabling the user to quickly improve accuracy and tone of the message before sending.

According to another aspect, the processor is configured to analyze content of a text to be viewed by a recipient and extract information including at least a main point, a deadline, and stakeholders from the content. In this configuration, the processor may use natural language processing and prompts supplied to the generative artificial intelligence model to identify sentences or phrases that express the essential purpose of the message, time constraints such as due dates, and names or designations of persons involved in the relevant task or project. The extracted information is structured as key items.

Furthermore, the processor is configured to cause extracted information to be displayed on a terminal of the user. In particular, when the user acts as a recipient, the terminal may show the main point, the deadline, and the stakeholders in a popup window, sidebar, or other user interface component associated with the received message. In this manner, the user can quickly understand what is requested, by when, and who is involved, without carefully reading the entire text each time. By combining the above configurations, the system provides integrated support for both composing and reading messages, thereby solving the aforementioned problems in conventional communication systems.

The term “system” refers to an information processing apparatus or a combination of one or more hardware devices and software components that cooperatively perform the functions described in the claims.

The term “processor” refers to a hardware processing unit, such as a central processing unit (CPU), a graphics processing unit (GPU), a digital signal processor (DSP), or any other circuitry, or a combination of such elements, configured to execute instructions to perform the operations described in the claims.

The term “text” refers to a sequence of characters, words, or sentences in a natural language, including but not limited to Japanese, which is input, transmitted, received, or processed by the system.

The term “tokenize” refers to processing the text to divide it into smaller units, such as characters, words, morphemes, or phrases, for the purpose of analysis, detection, or generation.

The term “typographical errors and omissions” refers to unintended mistakes in the text, including misspellings, incorrect characters, missing characters, missing words, and similar defects that deviate from an intended correct expression.

The term “generative artificial intelligence model” refers to a machine learning model, such as a neural network-based language model, that is configured to generate or transform natural language text in response to input data or instructions.

The term “prompt sentence” refers to a text string or set of instructions that is supplied to the generative artificial intelligence model to specify a desired operation, such as correction of typographical errors or generation of a politeness-improving rewrite proposal.

The term “correction proposal” refers to text generated by the generative artificial intelligence model that includes one or more candidate corrections for typographical errors and omissions detected in the original text.

The term “rewrite proposal for improving politeness” refers to text generated by the generative artificial intelligence model that represents a rewritten version of the original text, in which the tone, politeness level, or style is modified while substantially preserving the original meaning.

The term “analyze content” refers to processing the text to understand its structure and semantics, including identifying the purpose, important elements, and relationships within the text.

The term “main point” refers to a core purpose, essential subject matter, or primary request expressed in the text, summarized in a concise form.

The term “deadline” refers to a time or date by which an action requested or described in the text is required or expected to be completed.

The term “stakeholders” refers to persons or entities, such as individuals, groups, or organizations, that are involved in, responsible for, or affected by the subject matter or tasks described in the text.

The term “terminal” refers to any user-operated device, such as a personal computer, smartphone, tablet, or similar apparatus, that can communicate with the system and present information, including extracted information, to the user.

The term “extracted information” refers to information, such as the main point, the deadline, and the stakeholders, that is obtained from the text by the processor through analysis and is separated and structured for display or further processing.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

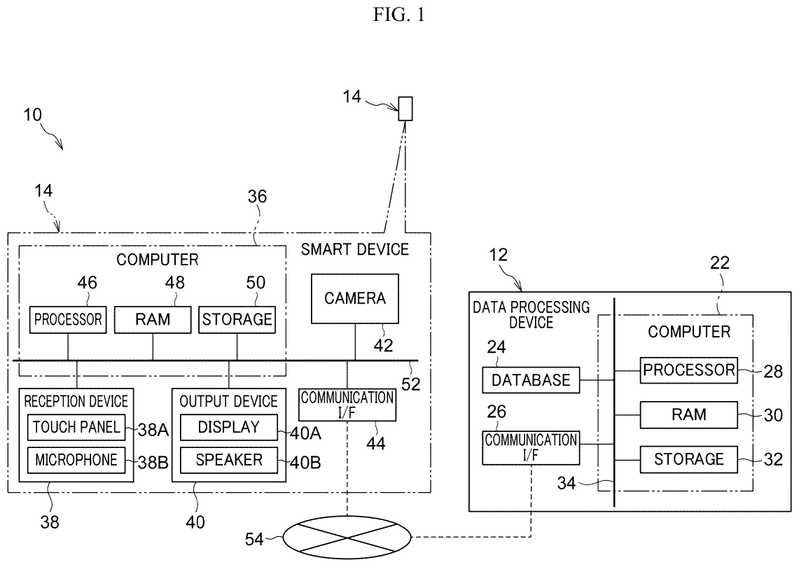

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

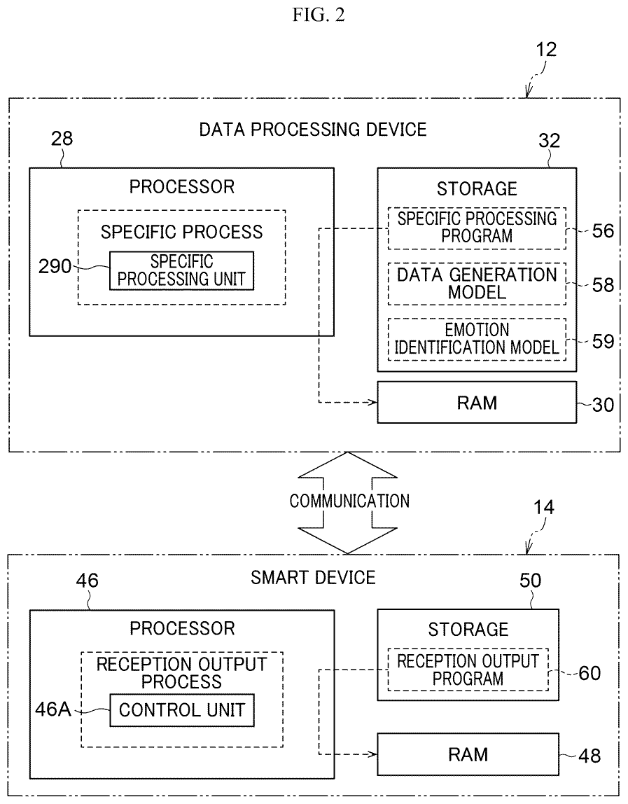

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional text assistance systems that rely on rule-based spell checkers or template-based rewriting engines are limited in their ability to flexibly improve user-authored text while maintaining the intended meaning and context. These systems typically operate on the user terminal and apply fixed linguistic rules, resulting in several technical drawbacks: processing logic is fragmented between client and server; network communication is not optimized for interactions with a remote generative AI model; and the system fails to produce structured outputs, such as clearly delineated error locations, improved sentences, key points, deadlines, and related entities, in a machine-usable form. As a result, the terminal-side user interface must perform ad hoc parsing of plain text explanations, which increases processing overhead, complicates state management, and reduces the reliability and determinism of the human-computer interaction.

Furthermore, existing approaches often treat the generative AI model as a black-box text generator, without defining an explicit processing pipeline that: (i) normalizes and structures user input on the server, (ii) constructs prompt sentences that encode fine-grained processing types, and (iii) converts model responses into standardized data structures suitable for automated highlighting, comparison, and categorization on the terminal. This lack of end-to-end integration leads to inefficiencies in server resource utilization, unnecessary round trips between client and server, and ambiguous presentation of results to the user. It also hinders the ability of the computing system to assist the user in iteratively refining text while keeping contextual constraints, such as formality requirements or deadline extraction, consistently enforced.

There is therefore a need for an improved computer-implemented system and server-side processing architecture that centrally manages text normalization, prompt sentence generation, interaction with a generative AI model, and structured post-processing of model outputs, and that delivers machine-readable correction candidates, rewriting proposals, and extracted informational elements to the terminal. Such an architecture should reduce the processing burden on the terminal, standardize the protocol for interaction with the generative AI model, and enhance the predictability, efficiency, and usability of the overall text improvement and information extraction workflow.

The specific processing by the specific processing unit 290 of the data processing device 12 in Example 1 is realized by the following means.

The present invention provides a server comprising a processor configured to obtain character information input by a user via an information processing apparatus and to normalize and structure the character information, to generate, based on the structured character information and a processing type, a prompt sentence that instructs at least one of error identification, description improvement, politeness adjustment, summarization, deadline extraction, and related-entity extraction, and to transmit inquiry information including the prompt sentence to a generative AI model, to receive response information from the generative AI model and convert the response information into analysis result data including at least one of error locations, candidate improved sentences, candidate polite sentences, key-point information, date-and-time information, and related-entity information, and to generate output information based on the analysis result data and transmit the output information to a user terminal via a communication path. This enables a computer-centric improvement of text processing by centralizing normalization, prompt construction, and structured post-processing on the server, thereby optimizing interaction with the generative AI model, reducing client-side computation, and providing machine-readable correction and extraction results that can be deterministically highlighted, compared, and categorized on the user terminal.

The term “character information” refers to electronic data representing textual content composed of characters, symbols, or punctuation that is input by a user via an input interface of an information processing apparatus.

The term “information processing apparatus” refers to a computing device, such as a terminal or client device, that includes at least one processor and an input interface and is configured to transmit character information to a server.

The term “user terminal” refers to an information processing apparatus that presents output information to a user via a display interface and transmits user input and requests to a server via a communication path.

The term “processor” refers to one or more processing units, such as a central processing unit, a graphics processing unit, or a specialized accelerator, that execute instructions to perform the functions described in the claims.

The term “normalize” refers to processing character information to convert it into a standardized internal representation, including unifying encoding formats, line break formats, and removal or conversion of control characters.

The term “structure the character information” refers to processing normalized character information to obtain a structured representation, such as segmentation into sentences or tokens and organization into data fields, that can be programmatically analyzed.

The term “processing type” refers to information that designates at least one specific operation to be performed on the character information, such as error identification, description improvement, politeness adjustment, summarization, deadline extraction, or related-entity extraction.

The term “prompt sentence” refers to a text string including an instruction part and the character information or a representation thereof, which is provided as input to a generative AI model to cause the model to perform a specified processing type.

The term “inquiry information” refers to data transmitted from the server to the generative AI model, the data including at least the prompt sentence and optionally including additional control parameters.

The term “generative AI model” refers to a machine-learned model, such as a neural network language model, that generates output text or structured data in response to input text including a prompt sentence.

The term “response information” refers to data returned from the generative AI model to the server in response to inquiry information, the data including generated text and optionally structured elements.

The term “analysis result data” refers to data obtained by the processor by analyzing the response information and mapping at least part of the response information into structured fields such as error locations, candidate improved sentences, candidate polite sentences, key-point information, date-and-time information, and related-entity information.

The term “error identification” refers to detection of portions of the character information that include spelling mistakes, typographical errors, missing characters, or similar inaccuracies.

The term “error locations” refers to positions or ranges within the character information that are determined to include errors as a result of error identification.

The term “description improvement” refers to modification of the character information to increase clarity, readability, or coherence without changing an intended meaning of the original content.

The term “politeness adjustment” refers to modification of expressions in the character information to conform to a desired level of formality or courtesy appropriate for a given communication context.

The term “candidate improved sentences” refers to alternative sentence-level expressions proposed as improvements over corresponding portions of the original character information, typically to enhance clarity or style.

The term “candidate polite sentences” refers to alternative sentences proposed to replace original sentences that are judged to be overly casual or inappropriate in formality, the alternatives being formulated with higher politeness.

The term “summarization” refers to generation of an abridged representation of the character information that retains essential points while omitting less important details.

The term “key-point information” refers to information items identified as core or essential content elements within the character information, such as main actions, decisions, or requirements.

The term “deadline extraction” refers to detection and extraction of time-related expressions in the character information that represent due dates, target dates, or time limits associated with tasks or events.

The term “date-and-time information” refers to information elements representing dates, times, or time ranges extracted from the character information or from response information.

The term “related-entity extraction” refers to detection and extraction of entities, such as persons, organizations, or groups, that are related to actions, responsibilities, or events described in the character information.

The term “related-entity information” refers to information elements indicating entities that are involved in, affected by, or otherwise related to the content of the character information, such as participants, responsible parties, or recipients.

The term “output information” refers to data generated by the processor based on the analysis result data, the data being formatted for transmission to and presentation on a user terminal and including at least one of error-related information, improved text, and extracted informational elements.

The term “communication path” refers to a logical or physical connection that enables data transfer between the server and a user terminal, including one or more wired or wireless networks.

The term “display control” refers to processing performed by a processor to cause a user terminal to render visual information on a display, including highlighting, layout, and arrangement of elements.

The term “visually highlight” refers to presenting portions of text or other elements in a manner that makes them visually distinct from surrounding content, such as by color change, underlining, boldness, or background shading.

The term “rewrite proposals” refers to candidate alternative expressions or sentences generated to replace or modify original portions of the character information according to at least one processing type.

The term “selection operation” refers to user input that indicates acceptance, rejection, or choice among one or more candidate corrections, improved sentences, or rewrite proposals.

The term “re-editing operation” refers to user input that manually modifies the character information or the suggested text after presentation of output information.

The term “list format” refers to a presentation format in which information elements are arranged as a sequence of items, such as bullet points or numbered entries, grouped according to categories.

In one embodiment, a server cooperates with a terminal used by a user to implement the claimed system. The server includes at least one processor, a main memory, a non-volatile storage device, and a network interface. For example, the server runs on a general-purpose computer platform such as a rack-mounted computing device equipped with a central processing unit (CPU) and optionally a graphics processing unit (GPU). The CPU can be a multi-core processor, and the GPU can be a programmable accelerator suitable for execution of matrix operations. The server runs an operating system such as a general-purpose server operating system, and an application framework such as a web service framework.

The server executes a server-side application that implements text normalization, prompt sentence generation, communication with a generative AI model, analysis of response information, and generation of output information for the terminal. The server stores program instructions and configuration data in the non-volatile storage and loads them into main memory for execution by the processor.

The terminal is an information processing apparatus such as a mobile communication device, a tablet information device, or a personal computing device. The terminal includes a processor, a memory, an input interface such as a touch panel or keyboard, a display device such as a liquid crystal display or organic light emitting display, and a network interface such as a wireless communication module. The terminal executes an application or browser-based client that provides an input field for character information and a result view for output information.

The user operates the terminal to input character information. The user enters sentences, paragraphs, or longer documents through the input interface. The terminal internally represents the character information as a text string in a standardized encoding such as UTF-8 and associates metadata such as language type and requested processing type.

The server obtains the character information from the terminal via a communication path using a network protocol such as HTTPS over a packet-switched network. The server parses incoming data packets to reconstruct a request message that contains the character information and processing type.

The server normalizes the character information by converting character encoding into a standard form, unifying line break codes, and removing non-printable control characters. The server can further perform Unicode normalization so that canonically equivalent characters share a common code representation. This normalization reduces data variability and ensures that downstream processing components, including the generative AI model, receive consistent input data, which improves reproducibility and reduces error rates in tokenization.

The server structures the character information by segmenting it into sentences and tokens. The server can use a natural language processing library that implements tokenization and sentence boundary detection. The server stores the structured character information in a data structure such as an array of sentence records, each sentence record including a sequence of token records with character offsets. By storing character offsets, the server can later map error locations returned from analysis back to the original character positions, which enables precise highlighting on the terminal. This structured representation also allows the server to compute statistics and context windows efficiently, which improves the performance of subsequent analysis and alignment operations.

The server determines a processing type for each request. The processing type can indicate one or more operations, such as error identification, description improvement, politeness adjustment, summarization, deadline extraction, and related-entity extraction. The server stores, in configuration memory, a mapping from processing types to prompt templates and expected output formats. Each prompt template includes an instruction portion and a placeholder portion for the user text.

The server generates a prompt sentence by combining a prompt template with the normalized character information. For example, the server can generate a prompt sentence in the following form:

“Please analyze the following text, point out all spelling mistakes or missing characters, and propose a corrected and more polite version suitable for business communication. Text: «[user text]»”

In another example, the server can generate a prompt sentence:

“Please summarize the following text and list: (1) the key points, (2) any dates that appear to be deadlines, and (3) any people or organizations that appear to be related entities. Text: «[user text]»”

The server inserts the normalized user text into the placeholder, and escapes or encodes special characters where appropriate. The server can also embed markers around the user text so that the generative AI model can reliably distinguish between instruction and data portions, which leads to more stable and predictable outputs. Because the server centralizes prompt sentence generation, it can optimize the wording, structure, and length of prompts based on empirical model behavior, thereby improving overall processing accuracy and response latency.

The server transmits inquiry information including the prompt sentence to a generative AI model. In one embodiment, the generative AI model is deployed as a network-accessible model execution service. The server forms a request message containing the prompt sentence and model parameters such as maximum output length, sampling temperature, and decoding strategy. The server sends this request via the network interface to a model-serving component. In another embodiment, the generative AI model is deployed locally on the same hardware as the server. In that case, the server loads a trained model from storage into GPU memory and performs inference using a neural network library.

The generative AI model is a machine-learned model of the neural network type, for example, a transformer-based language model. The generative AI model comprises multiple layers of self-attention blocks, feed-forward blocks, and embedding blocks. The model internally converts the prompt sentence into subword tokens using a tokenizer. Each token is mapped to a dense vector representation using an embedding matrix stored as model parameters. The model processes these embeddings through multiple transformer layers that perform multi-head self-attention and non-linear transformations. During training, the model has been adjusted using a large text corpus. The model parameters were optimized using a loss function such as cross-entropy loss, and an optimization algorithm such as stochastic gradient descent or an adaptive variant. The model can be fine-tuned for instruction following by supervised fine-tuning and optionally further aligned using reinforcement learning from human feedback, in which a reward model evaluates quality of outputs and an optimization loop updates model parameters to maximize expected reward.

The generative AI model generates, as response information, output tokens conditioned on the prompt sentence. For error identification and description improvement, the model produces text that describes errors, provides corrected forms, and presents improved sentences. For politeness adjustment, the model proposes alternative sentences with higher formality, respecting linguistic politeness rules embedded in its parameters. For summarization, deadline extraction, and related-entity extraction, the model produces summaries and lists of date expressions and participant entities.

The server receives the response information and converts it into analysis result data. If the response information is in a semi-structured text format, the server parses the text based on delimiters and labels included in the prompt specification. In some embodiments, the server instructs the generative AI model to output a machine-readable structure, such as pseudo-JSON text blocks. The server corrects formatting irregularities by applying syntax repair rules, then parses the blocks into structured records. The structured records can contain fields for error locations, candidate improved sentences, candidate polite sentences, key-point information, date-and-time information, and related-entity information.

The server aligns error locations with the original character information using the structured representation that records character offsets. The server can compute edit distances between segments of the original text and the candidate improved sentences to infer correspondences between old and new spans. This alignment allows the server to compute precise error positions for highlighting. By offloading this alignment and structuring procedure to the server, the system avoids heavy text-diff computations on the terminal and ensures consistent mapping across devices.

The server generates output information based on the analysis result data. The output information can include: a corrected version of the text, an improved version with politeness adjustment, a list of error entries (each entry containing an error type, location range, and suggested correction), a set of key points summarized in short sentences, extracted date-and-time items normalized to a standard format, and related-entity items tagged with entity types such as person or organization. The server packages these elements in a structured format for transport to the terminal.

The server transmits the output information to the terminal via the communication path. The server may compress the output information or omits redundant data where possible to reduce communication load. Because the server provides pre-structured and aligned output, the terminal does not need to execute complex language analysis or diff algorithms, which reduces processor usage and memory consumption on the terminal.

The terminal receives the output information and performs display control. The terminal generates display objects corresponding to the original character information and the improved text. The terminal uses the error location data to visually highlight portions of the original text, for example by underlining, changing text color, or applying background shading. The terminal displays the candidate improved sentences and candidate polite sentences in proximity to the original segments, so that the user can easily compare them. The terminal also displays key-point information, date-and-time information, and related-entity information in list form, categorized under headings such as “Key points,” “Deadlines,” and “Participants.”

The user reviews the display on the terminal. The user can select one of multiple candidate sentences or manually re-edit the text. The terminal sends the result of the user selection or re-editing back to the server if further processing is requested. The user thus interacts with a user interface that is backed by a computing pipeline optimized for generative text analysis. This configuration provides technical effects beyond mere automation of human text editing. The server centralizes and standardizes prompt sentence generation and output structuring, which directly improves computational efficiency. By using structured character information, token-level offsets, and standardized templates, the server reduces ambiguity in generative AI model responses, thereby reducing the need for repeated queries and lowering network traffic load. The server's alignment algorithm based on edit distance and token mapping minimizes the computational complexity on the terminal. These design choices lead to faster response times and lower error rates in mapping model-generated corrections to original text.

The use of a transformer-based generative AI model, together with server-driven prompt templates and alignment logic, also improves the accuracy of operations such as deadline extraction and related-entity extraction when compared to traditional rule-based approaches. For example, the model can interpret context-dependent date expressions and role descriptions, which would be difficult to manage with static rules alone. The server exploits these capabilities in a constrained framework by specifying in the prompt sentence what categories of information must be extracted and how they should be listed, thus turning the model into a programmable text transformation and extraction engine.

The server further improves computing resource utilization by separating tasks: the generative AI model focuses on high-level language-to-language transformation, while the server undertakes low-level structuring, error mapping, and normalization. This modular separation allows the server to cache prompt results and reuse intermediate analysis results across multiple terminals or user sessions, which further reduces computation and communication load.

In some embodiments, the server uses different generative AI models or decoding configurations depending on the processing type or text length. For short texts requiring rapid feedback, the server can select a smaller model or limit the maximum generated token count, which reduces inference time and energy consumption. For longer documents where summarization accuracy is crucial, the server can select a larger model and enable more detailed instructions in the prompt sentence. The server can store, in configuration memory, threshold values for text length and processing type, and automatically route each request to an appropriate model configuration, thereby improving the balance between latency and quality.

In other embodiments, the server augments the generative AI model with deterministic preprocessing and post-processing rules. For example, the server can apply a preliminary regular-expression-based check for obvious spelling errors or simple date formats and annotate such occurrences in the structured character information. The server can then instruct the generative AI model, through the prompt sentence, to focus on more complex linguistic phenomena such as tone, indirect references to deadlines, and ambiguous entity mentions. This cooperative processing reduces unnecessary neural computation and focuses model capacity on non-trivial cases, improving both speed and accuracy.

Because the server and terminal collaborate via clearly defined data structures and prompt sentences, the system can be deployed in different network topologies and computing environments. In all cases, the core technical contribution lies in the way the server structures character information, generates and manages prompt sentences for a generative AI model, converts response information into analysis result data with explicit locations and categories, and supplies output information in a machine-usable form that directly drives display control on the terminal. This architecture yields concrete improvements in processing speed, accuracy of highlighting and extraction, data management, and communication efficiency, and thus constitutes an improvement in computer technology itself, rather than merely automating human text editing tasks.

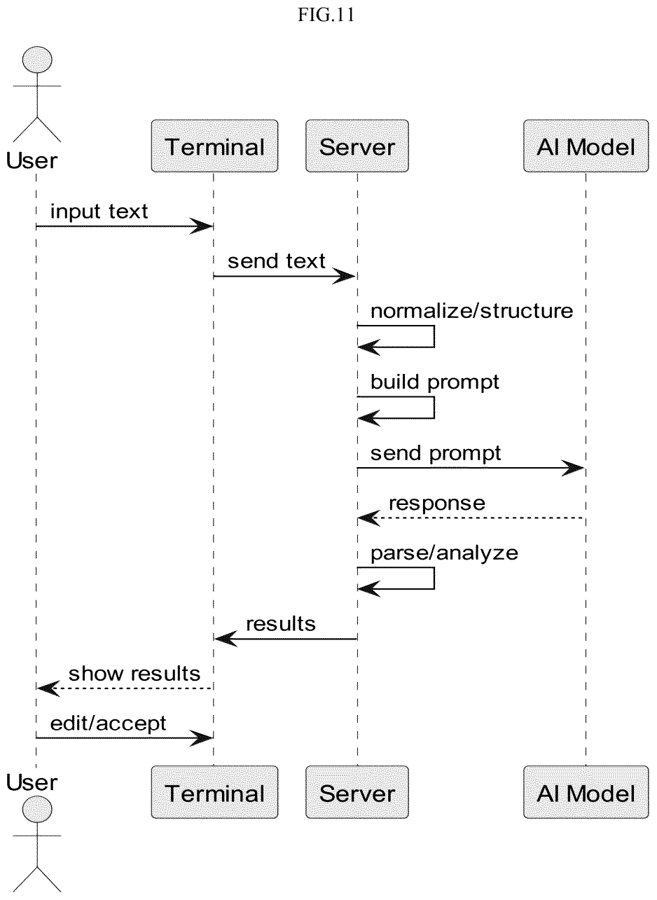

The following describes the processing flow using FIG. 11.

Step 1:

User operates the terminal to input character information into an input field of an application or browser.

User provides as input raw textual content, such as sentences or paragraphs, through a keyboard or touch interface.

User confirms the input by activating a control element such as a “Check” button.

User thus outputs character information and a request to initiate analysis.

Step 2:

Terminal receives the user input from the input interface and generates an internal text representation.

Terminal treats the character information and optional metadata (for example, language tag and requested processing type) as input.

Terminal performs data processing by encoding the text as a UTF-8 string, attaching a processing type such as “correction_and_politeness” or “summary_with_deadlines,” and packaging these into a structured request object.

Terminal outputs a request message including the character information and metadata.

Step 3:

Terminal establishes a secure communication session with the server using a network interface.

Terminal uses the request message as input and applies a transport protocol such as HTTPS to encapsulate the data.

Terminal performs data processing by adding protocol headers, encrypting the payload with a transport layer security mechanism, and fragmenting the message into packets suitable for transmission.

Terminal outputs encrypted network packets that are transmitted to the server.

Step 4:

Server receives the network packets from the communication path and reconstructs the request message.

Server uses the packets as input and applies network stack processing to reassemble the HTTP message and decrypt the payload.

Server parses the request body, extracting the character information, language indicator, and processing type, and verifies integrity and completeness of the data.

Server outputs a normalized internal representation of the request containing raw text and associated parameters.

Step 5:

Server normalizes the character information to obtain a standardized text form.

Server takes as input the raw text string from the request representation.

Server performs data processing by converting character encoding to a uniform format, unifying line breaks, applying Unicode normalization, and removing or replacing control characters that could interfere with downstream tokenization.

Server outputs a normalized text string that serves as a consistent basis for later processing.

Step 6:

Server structures the normalized text into sentences and tokens.

Server uses the normalized text as input and applies a natural language processing library to detect sentence boundaries and token positions.

Server performs data operations that segment the text, compute character offsets for each token, and create an array or list of sentence objects each containing ordered token objects and offsets.

Server outputs a structured text representation that maps logical units (sentences and tokens) to physical positions in the original text.

Step 7:

Server determines the processing type and selects a corresponding prompt template and output schema.

Server uses as input the processing type value and configuration data stored in memory.

Server performs a lookup operation to identify a prompt template, expected sections in the response, and post-processing rules appropriate for error identification, description improvement, politeness adjustment, summarization, deadline extraction, or related-entity extraction.

Server outputs a selected prompt template and an associated processing profile.

Step 8:

Server generates a prompt sentence by combining the prompt template with the normalized text.

Server uses as input the selected prompt template and the normalized text string.

Server performs data operations including string concatenation, insertion of the user text into a placeholder, and, where required, insertion of markers or labels that will guide the generative AI model's output structure.

Server outputs a complete prompt sentence that encodes the instructions and the text to be analyzed.

Step 9:

Server forms inquiry information for the generative AI model and invokes a model interface.

Server takes as input the prompt sentence and model control parameters such as maximum output length and decoding settings.

Server performs data processing by wrapping the prompt sentence and parameters into a request format defined by a model-serving API, adding authentication tokens, and serializing the data for transmission.

Server outputs a model request message that is sent to the generative AI model via a network or local inter-process communication.

Step 10:

Generative AI model receives the prompt sentence and generates response information.

Generative AI model uses the model request, including the prompt sentence, as input.

Generative AI model performs internal data operations: it tokenizes the prompt sentence, maps tokens to embeddings, applies multiple transformer layers with self-attention and feed-forward computations, and then generates output tokens according to decoding parameters until a stopping condition is met.

Generative AI model outputs response text that may include descriptions of errors, corrected sentences, improved polite sentences, summaries, key points, deadlines, and related entities in accordance with instructions embedded in the prompt sentence.

Step 11:

Server receives the response information from the generative AI model.

Server uses the model output text as input and decodes it from the transport format used by the model interface.

Server verifies that the response is complete and free from protocol-level errors, and separates the main content from any metadata returned by the model.

Server outputs a raw response string ready for further analysis.

Step 12:

Server parses the response string and converts it into analysis result data.

Server takes the raw response string as input and applies parsing rules that correspond to the prompt template and processing profile.

Server performs data operations such as pattern matching, delimiter-based splitting, and optional syntax repair to identify portions corresponding to error descriptions, corrected sentences, improved polite sentences, key points, date-and-time expressions, and related entities.

Server maps these portions into structured fields and computes, where needed, character-level or token-level indices by aligning model-provided text with the structured text representation.

Server outputs analysis result data as a structured internal data object containing categorized elements and their positions.

Step 13:

Server generates output information for delivery to the terminal.

Server uses the analysis result data as input and selects the subsets required for terminal display, such as original text, corrected text, improved politeness text, lists of errors with locations and corrections, key points, deadlines, and related entities.

Server performs data processing by formatting these elements into a compact representation, optionally normalizing dates into a standard format, merging duplicated entries, and assigning category labels for display grouping.

Server outputs output information that encapsulates all elements the terminal needs to render user-facing results.

Step 14:

Server transmits the output information to the terminal via the communication path.

Server uses the output information as input and encapsulates it into a response message for a network protocol such as HTTPS.

Server performs operations such as serialization, optional compression, encryption, and packetization, and then sends the response to the terminal's network address.

Server outputs encrypted network packets that carry the structured output information to the terminal.

Step 15:

Terminal receives the response packets and reconstructs the output information.

Terminal uses the incoming packets as input and applies network stack processing and decryption to recover the response message.

Terminal deserializes the payload, parses the structured data, and verifies that required fields such as corrected text and error locations are present.

Terminal outputs a set of internal data structures representing the original text, improvement candidates, and extracted informational elements.

Step 16:

Terminal performs display control to present the output information to the user.

Terminal uses the internal data structures as input, including original text, corrected versions, error locations, key points, deadlines, and related entities.

Terminal performs data operations that generate layout objects, calculate text ranges to highlight based on error locations, associate each error with at least one correction candidate, and build list views for key points and other extracted items.

Terminal outputs rendered visual content on the display device, showing highlighted errors, side-by-side original and suggested sentences, and categorized lists of key information.

Step 17:

User reviews the displayed information and performs selection or re-editing operations.

User takes the visual content on the terminal display as input and decides whether to accept suggested corrections or modify the text manually.

User performs data entry operations, such as tapping on specific suggestions, selecting among multiple rewrite proposals, or editing the text in the input field.

User outputs updated character information and, if desired, a request for further processing, which can be sent back to the server through repetition of the earlier steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Natural language communication using computing devices is increasingly performed through text messaging, email, chat systems, and voice-based interactions. However, conventional systems that assist users in composing or understanding natural language messages typically rely on simple spell-checkers, rule-based grammar tools, or static templates. These conventional systems suffer from several technical limitations.

First, conventional systems generally process user input in a linear and isolated manner, performing basic error detection or superficial rewriting without maintaining a coherent dialogue state across multiple turns of interaction. As a result, such systems cannot adapt their processing to the evolving context of a conversation, and they often require repeated manual operations by the user, which increases latency and processing overhead at both the client side and the server side.

Second, conventional systems that perform text correction or summarization rarely integrate speech recognition and advanced generative models in a unified processing pipeline. Voice input is often handled separately from text correction and summarization, and outputs from speech recognition are not systematically transformed into optimized prompts for a generative model. This fragmented processing leads to inefficient use of computing resources, redundant conversions, and inconsistent output quality between voice-based and text-based interactions.

Third, conventional systems typically do not leverage structured prompt sentences with explicit constraints on style, politeness level, length, and output format when interacting with advanced generative models. Without such structured prompts and constraint-based control, the generative models may produce responses that are overly long, inconsistent in tone, or unsuitable for time-sensitive real-time scenarios such as in-person customer service. This reduces the practical utility of generative models in systems that must provide concise, context-appropriate responses with low latency.

Fourth, conventional systems often fail to extract, structure, and present key information such as main points, deadlines, and stakeholders from long messages in a machine-efficient manner. They typically provide only plain-text summaries, without generating structured data that can be directly used by a client device to render popup displays or other focused user interface elements. This lack of structured information limits the ability of client devices to manage screen space effectively and to assist the user in quickly understanding critical information while minimizing cognitive load.

Accordingly, there is a need for an improved computer-implemented system and server-side processing architecture that (i) unifies acquisition of character and voice input, (ii) automatically generates optimized prompt sentences for a generative AI model with explicit constraint conditions, (iii) manages a dialogue state across multiple interactions, and (iv) outputs both refined natural language text and structured information suitable for efficient, context-aware visual presentation, including popup displays. Such an improvement should enhance the technical functioning of the server and client devices by reducing redundant processing, improving consistency of outputs across modalities, and enabling real-time, context-sensitive assistance in natural language communication.

The specific processing by the specific processing unit 290 of the data processing device 12 in Application Example 1 is realized by the following means.

The present invention provides a server comprising a processor configured to acquire character information or voice information from a user information processing terminal, convert the voice information into character information by using a speech recognition technique, tokenize the character information, detect an error or an omission in a character string in the tokenized character information, assign evaluation information relating to politeness and clarity to the character information, generate a prompt sentence that instructs correction of the error or the omission and rewriting for improving politeness or clarity of the character information, input the prompt sentence together with the character information into a generative artificial intelligence model, cause the generative artificial intelligence model to generate a correction proposal or a rewriting proposal, analyze long character information to be viewed by a recipient, extract key point information, deadline information, and stakeholder information from the long character information, generate a prompt sentence for inputting an extraction result into the generative artificial intelligence model, cause the generative artificial intelligence model to generate summary information and structured information, process the correction proposal, the rewriting proposal, the summary information, or the structured information output from the generative artificial intelligence model into display control data for presenting the correction proposal, the rewriting proposal, the summary information, or the structured information on a display device of the user information processing terminal in a display format including a popup display, and manage a dialogue state on the basis of the character information or the voice information transmitted from the user information processing terminal and information output from the generative artificial intelligence model so as to repeatedly control the acquisition and presentation processing. This enables an integrated, server-centered processing pipeline that improves the technical functioning of the computer system by unifying speech and text handling, dynamically constructing constraint-based prompt sentences for the generative artificial intelligence model, maintaining conversation context, generating both refined natural language text and structured key information, and supplying optimized display control data to the user information processing terminal for real-time, context-aware visual presentation with reduced processing redundancy and improved responsiveness.

The term “system” refers to a combination of one or more hardware devices and software components that cooperate to execute the processing described in the claims.

The term “processor” refers to a hardware information processing unit, such as a central processing unit or a computing core, that executes software instructions to perform the functions recited in the claims.

The term “user information processing terminal” refers to an electronic device operated by a user, such as a mobile computing device, a wearable computing device, or a general-purpose computer, that includes at least an input device and a display device and communicates with the server.

The term “character information” refers to data representing natural language content as a sequence of symbols, such as letters, numerals, punctuation marks, or other text elements encoded in a digital format.

The term “voice information” refers to audio data representing speech uttered by a user and captured as an analog or digital acoustic signal.

The term “speech recognition technique” refers to a software-implemented procedure that analyzes voice information and outputs corresponding character information by mapping acoustic features to linguistic units.

The term “tokenize” refers to processing character information to segment the character information into smaller units, such as words, subwords, or symbols, that can be individually analyzed or processed.

The term “error or omission in a character string” refers to an unintended discrepancy in character information, including at least a misspelling, an incorrect character, a missing character, or an extraneous character that degrades correctness of the text.

The term “evaluation information relating to politeness and clarity” refers to metadata or score data indicating a level of courteousness, formality, readability, or comprehensibility of character information according to predefined criteria.

The term “prompt sentence” refers to a natural language instruction sequence, optionally including placeholders and constraint conditions, which is supplied as input to a generative artificial intelligence model to control generation of output text or structured data.

The term “generative artificial intelligence model” refers to a machine-learned computational model that receives input data including a prompt sentence and produces new text or structured information by predicting sequences of tokens according to learned statistical patterns.

The term “correction proposal” refers to character information generated to replace or amend original character information so as to reduce or remove errors or omissions in the original character information.

The term “rewriting proposal” refers to character information generated to replace or rephrase original character information so as to improve at least politeness, clarity, style, or other linguistic quality while preserving an intended meaning.

The term “long character information” refers to character information whose length exceeds a predetermined threshold or whose content is complex enough that understanding it directly imposes a relatively high cognitive load on a user.

The term “key point information” refers to data representing main ideas, important topics, or essential statements extracted from long character information.

The term “deadline information” refers to data representing due dates, times, or time limits mentioned or implied in long character information.

The term “stakeholder information” refers to data representing persons, organizations, or roles that are involved in, responsible for, or affected by content of long character information.

The term “summary information” refers to condensed character information that expresses, in a shorter form, main content or overall meaning of original character information.

The term “structured information” refers to information arranged according to a predefined data structure, such as a set of fields, lists, or key-value pairs, that can be programmatically processed or displayed.

The term “display device” refers to a hardware component, such as a screen, panel, or projection unit, capable of visually presenting text, graphics, or user interface elements to a user.

The term “popup display” refers to a visual user interface element that appears temporarily or in an overlaid manner relative to other content on the display device to highlight or emphasize particular information.

The term “display control data” refers to data that specifies content, layout, style, or behavior of visual elements to be rendered on a display device, including at least position, size, and type of popup displays or main text areas.

The term “acoustic input/output device” refers to a hardware component configured to at least capture sound, such as a microphone, and optionally output sound, such as a speaker or earpiece, for interaction with a user.

The term “response sentence” refers to character information that is generated or selected for presentation to a user as a candidate utterance or reply in a communication scenario.

The term “customer service interaction” refers to an exchange of information between a user and another person in which the user provides assistance, explanations, or guidance regarding a product, service, or inquiry.

The term “dialogue state” refers to data representing a current context of an interaction, including at least previous user inputs, generated outputs, and processing mode, used to control subsequent processing steps.

The term “constraint conditions” refers to explicit rules or parameters, such as a required style, honorific level, length limit, or output format specification, that govern how the generative artificial intelligence model should generate its output.

In one embodiment, a server cooperates with one or more terminals operated by a user to implement the claimed system. The server includes at least one processor, main memory, nonvolatile storage, and a network interface. The terminal includes at least one processor, a memory, a display device, an acoustic input/output device such as a microphone and a speaker, and a network interface. The server and the terminal communicate via a digital communication network, such as a wireless local area network or a mobile communication network, using a transport protocol such as TCP/IP and an application protocol such as HTTPS.

The server executes an operating system such as a general-purpose server operating system and executes an application program that implements acquisition, analysis, prompt generation, interaction with a generative AI model, generation of display control data, and dialogue state management. The terminal executes a client application on an operating system such as a mobile operating system. The client application acquires character information or voice information from the user, transmits the information to the server, receives display control data from the server, and controls the display device to present correction proposals, rewriting proposals, summary information, and structured information.

The server stores, in the nonvolatile storage, multiple software modules including at least: a text preprocessing module, an error and omission detection module, a politeness and clarity evaluation module, a prompt generation module, a generative AI interface module, a long-text analysis module, a key information extraction module, a display control data generation module, and a dialogue state management module. Each module is realized as executable instructions that, when executed by the processor of the server, cause the processor to perform the data processing described below.

The terminal acquires voice information by controlling the acoustic input/output device. For example, the terminal uses an audio acquisition application programming interface, such as an audio recording interface on a mobile operating system, to sample analog voice signals at a certain sampling frequency, such as 16 kHz, and convert the signals into digital pulse-code-modulated audio data. The terminal optionally applies noise reduction and echo cancellation by invoking built-in digital signal processing functions. The terminal converts the audio data into a format compatible with a speech recognition technique, such as a linear pulse-code-modulated format or a compressed audio format.

The terminal applies a speech recognition technique to the voice information. In one embodiment, the terminal sends the audio data to an external speech recognition service via HTTPS and receives character information as a recognition result. In another embodiment, the terminal executes a local speech recognition engine. The speech recognition engine uses an acoustic model and a language model to convert sequences of acoustic feature vectors into sequences of tokens corresponding to characters or words. The terminal thereby obtains character information representing the user's utterance.

The terminal transmits the character information to the server over the network. The server receives the character information and stores it in memory as an internal data structure. For example, the server stores the character information as a sequence of tokens with associated attributes in a token array structure. The server then executes the text preprocessing module to normalize encoding, unify character sets, and remove unnecessary control characters.

The server executes the error and omission detection module to detect an error or an omission in a character string in the tokenized character information. In one embodiment, the server uses a dictionary-based checker combined with a statistical language model. The server compares each token or subsequence of tokens against entries in a normalized lexicon and computes an error score based on edit distance, occurrence frequency, and surrounding context. The server flags tokens whose error score exceeds a threshold as candidates for correction. The server may also detect omissions by analyzing unlikely token transitions and missing expected function words using an n-gram language model.

The server executes the politeness and clarity evaluation module to assign evaluation information relating to politeness and clarity to the character information. In one embodiment, the server applies a classifier implemented as a feedforward neural network or a recurrent neural network trained on labeled examples of polite and impolite, clear and unclear sentences. The server transforms each token into an embedding vector and feeds a sequence of embeddings to the classifier. The classifier outputs scores representing estimated politeness level and clarity level. The server stores the scores as metadata associated with the character information.

The server executes the prompt generation module to generate a prompt sentence that instructs correction of the detected error or omission and rewriting for improving politeness or clarity of the character information. The server constructs the prompt sentence by combining a template and the original character information. For example, the server generates a prompt sentence such as:

“You are a writing assistant. The following text may contain spelling errors and unclear expressions. Please correct all errors and rewrite the text to be more polite and easy to understand, while preserving the original meaning. Text: ‘[user text]’.”

The server may embed additional constraint conditions, such as maximum output length and required tone, into the prompt sentence. For example, the server may generate a prompt sentence such as:

“Rewrite the following message in polite business English in no more than three sentences, avoiding technical jargon and maintaining the original intent. Message: ‘[user text]’.”

The server transmits the prompt sentence and the original character information to the generative AI model via the generative AI interface module. In one embodiment, the generative AI model is implemented as a transformer-based neural network with multiple attention layers, such as a decoder-only transformer trained on large-scale text data. The server calls an application programming interface provided by a generative AI model service. The server converts the prompt sentence into a sequence of tokens, applies positional encoding, and transmits the tokenized prompt as an input sequence to the generative AI model.

The generative AI model internally applies multi-head self-attention operations, feedforward network layers, and normalization layers to compute a probability distribution over output tokens for each time step. The model uses learned weight matrices, which have been optimized in a pretraining phase by minimizing a loss function such as cross-entropy between predicted tokens and ground-truth tokens on large training corpora. During generation, the model repeatedly selects output tokens according to the probability distribution, optionally using sampling parameters such as temperature or top-k filtering, to produce a correction proposal or a rewriting proposal. The server receives the generated token sequence as output from the generative AI model and converts it back into character information.

The server applies a similar procedure for long character information to be viewed by a recipient. The server executes the long-text analysis module and the key information extraction module to extract key point information, deadline information, and stakeholder information. In one embodiment, the server uses a combination of rule-based parsing and a named-entity recognition model. The server identifies date expressions, temporal expressions, person names, organization names, and salient sentences based on learned attention weights or feature scores. The server packages the extraction result as a structured intermediate representation, such as a set of fields containing “main points,” “deadlines,” and “stakeholders.”

The server generates a prompt sentence for inputting the extraction result into the generative AI model. For example, the server generates a prompt sentence such as:

“Summarize the following content in three bullet points, and list all deadlines and involved persons or organizations. Output the result as short, clearly separated sections titled ‘Summary’, ‘Deadlines’, and ‘Stakeholders’. Content: ‘[long text]’.”

The server inputs this prompt sentence into the generative AI model and receives summary information and structured information. The model again uses its internal attention-based architecture and learned weights to identify important content and compose concise summaries according to the constraint conditions described in the prompt sentence. Because the prompt sentence includes explicit instructions for structure and output format, the model generates information in a predictable and machine-parseable arrangement, which improves downstream processing efficiency.

The server executes the display control data generation module to process the correction proposal, rewriting proposal, summary information, and structured information output from the generative AI model into display control data. The server maps logical elements, such as “main reply sentence” and “deadline list,” into visual components, such as main text areas and popup overlay elements. The server encodes properties such as position, size, font style, and display duration into a structured data format. For example, the server defines a popup descriptor that includes coordinates relative to the display device, z-order, display time interval, and associated text content.

The server transmits the display control data to the terminal. The terminal receives the display control data and applies it to the display device using a user interface framework. The terminal arranges the main text in a primary area and displays key point information, deadline information, or stakeholder information in popup displays that appear temporarily over other content. In one embodiment, the terminal is a wearable display device such as smart glasses, and the popup displays are positioned in the peripheral field of view to minimize obstruction while enabling quick recognition.

The server manages a dialogue state based on the character information or voice information transmitted from the terminal and the information output from the generative AI model. The server maintains, in memory, a dialogue state data structure including at least: a history of user inputs, a history of outputs provided to the user, current processing mode (such as correction mode, rewriting mode, or summary mode), and context variables such as language and politeness preferences. The server uses the dialogue state to select appropriate prompt templates, to adjust constraint conditions, and to determine whether to request additional information from the generative AI model. By centralizing dialogue state management, the server reduces redundant analysis of repeated context, thereby reducing processing time and network usage.

The terminal and the server thereby implement a unified processing pipeline that improves technical performance in several ways. Because the server constructs optimized prompt sentences that explicitly specify style, length, and structure, the generative AI model generates outputs requiring less post-processing and manual correction. This reduces computational load for subsequent formatting and lowers network bandwidth usage by avoiding transmission of unnecessary verbose content. The server also uses structured intermediate representations and extracted key information to generate compact display control data, which allows the terminal to render only essential parts of the information as popup displays, reducing screen refresh overhead and improving responsiveness on resource-constrained devices.

The use of a transformer-based generative AI model in combination with explicit constraint-based prompt sentences and structured dialogue state management differs from simple automation of human editing. The server operates with non-intuitive, computer-specific rules: it optimizes prompt structure based on error scores, politeness scores, and context; it splits long text into segments for parallel processing; and it selects generation parameters based on device characteristics and latency constraints. For example, when the server detects that the terminal is a wearable device with limited display area, the server sets a stricter maximum output length parameter in the prompt sentence and, consequently, the model internally adjusts its token-by-token generation process to favor shorter outputs. This direct interaction between system parameters and model behavior yields a technical effect of reduced display latency and improved usability in constrained hardware environments.

The server uses a training method for the generative AI model that includes pretraining on large-scale text corpora and optional fine-tuning on domain-specific datasets where polite responses, summaries, and corrections are labeled. During training, the model minimizes a loss function such as cross-entropy loss using an optimization algorithm such as stochastic gradient descent with adaptive learning rate adjustment. The training process updates the weight matrices of the multi-head attention layers and feedforward layers. This training allows the model to learn complex relationships among input tokens and constraints specified in prompt sentences. The server's design uses these learned relationships to convert evaluation information and extraction results into more accurate and context-sensitive outputs than could be obtained with conventional rule-based systems.

In additional embodiments, the server uses data augmentation methods for training, such as generating synthetic typos, politeness variations, and paraphrases, to increase robustness of the error detection and rewriting modules. The server uses an error function that emphasizes penalty on incorrect handling of deadlines and stakeholder names so that summary information preserves critical information with high accuracy. Thereby, the system reduces errors that could lead to misunderstanding in real-world communication.

In one concrete example, the user operates a terminal in a physical store. The user speaks a question received from a customer into the microphone. The terminal converts the voice information into character information and sends it to the server. The server detects that the input corresponds to a customer inquiry and generates a prompt sentence such as:

“Customer is asking about available colors of a product in a retail store. The customer's question is: ‘Does this product come in other colors?’. You are a polite and helpful store clerk. Generate a short, natural answer that can be spoken aloud.”

The server sends the prompt sentence to the generative AI model, receives a concise response such as “We also have this product in other colors. Which color would you prefer?”, and generates display control data for presenting this response prominently on the terminal's display device. The terminal immediately shows the response to the user, enabling real-time interaction. Because the server has optimized the length and style of the response through the prompt sentence, the terminal can render the text without additional truncation or reformatting, which reduces local computation and improves reaction time.

In another example, the user composes a long email on a smartphone and requests correction and summarization. The terminal sends the text to the server. The server analyzes the text, detects typographical errors, evaluates politeness, and constructs multiple prompt sentences. One prompt sentence requests a corrected and politely rewritten version. Another prompt sentence requests a summary of the content and extraction of deadlines and stakeholders. The generative AI model returns both a refined version of the email and structured summary information. The server generates display control data for showing the refined email in the main area and for showing key deadlines and stakeholders in popup displays. The user can quickly confirm the most important information without reading the entire email again. From a technical perspective, the server has reduced the quantity of data that must be transferred and rendered at full resolution, which contributes to lower communication load and more efficient device operation.

Alternative embodiments are also possible. The server may employ a different neural network architecture, such as an encoder-decoder transformer or a recurrent neural network with attention mechanisms. The server may use different speech recognition engines, including local models running on the terminal or on the server. The server may adjust prompt sentence templates and generation parameters according to the language, application domain, or device characteristics. The terminal may be a head-mounted display, a tablet, or a desktop computer. Despite these variations, the core concept of combining speech and text processing, explicit constraint-based prompt sentences, generative AI model interaction, structured information extraction, and display control data generation remains the same. By implementing these structures and operations, the server and the terminal cooperate to provide a computer-implemented system that improves the functioning of the computer itself. The system reduces redundant processing, manages dialogue state to avoid repeated computations, uses optimized prompt sentences to control model output length and structure, and generates display control data tailored to device capabilities. As a result, the system achieves improved processing speed, higher accuracy in error correction and information extraction, reduced communication load, and more efficient use of limited display resources, rather than merely automating human editing and summarization tasks.

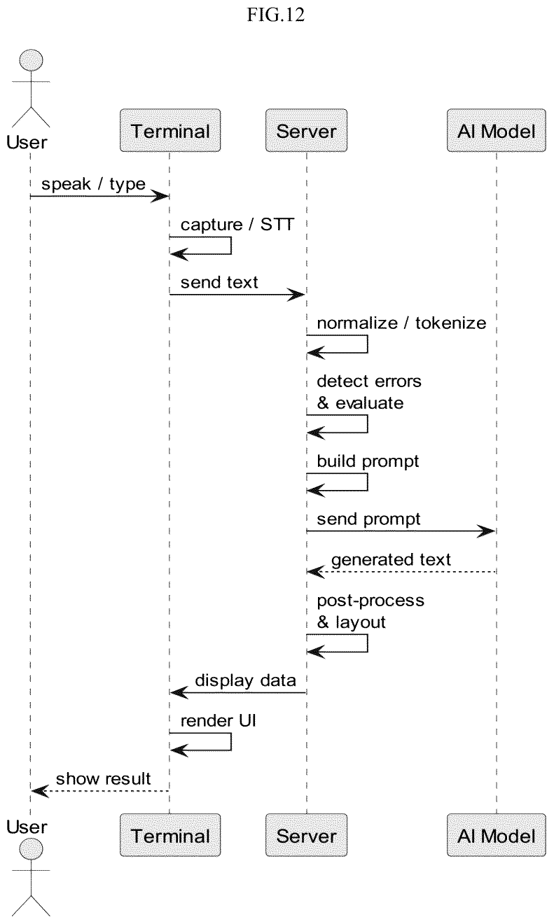

The following describes the processing flow using FIG. 12.

Step 1:

User provides an initial input.

User speaks a sentence or question into the microphone of the terminal, or types a text message into an input field displayed on the terminal. The input is raw voice information in the form of analog sound waves, or character information as a sequence of characters. User may, for example, ask “Does this product come in other colors?” or type a long email draft. The output of this step is either captured audio at the microphone or a text string held in the terminal's memory.

Step 2:

Terminal acquires and digitizes voice information.

Terminal receives the analog voice signal from the microphone and converts it into digital audio data using an internal codec and an audio driver of the operating system. The input is the analog electrical signal from the microphone. Terminal samples the signal at a fixed sampling rate (for example, 16 kHz) and quantizes each sample to a fixed bit depth (for example, 16 bits), thereby generating linear PCM audio frames. Terminal stores the frames in a buffer in main memory and may apply noise reduction and automatic gain control using built-in digital signal processing routines. The output of this step is a sequence of digital audio frames prepared for speech recognition.

Step 3:

Terminal converts voice information into character information.

Terminal invokes a speech recognition engine, either locally or on an external recognition service, to transform the digital audio into text. The input is the buffered digital audio frames. Terminal extracts acoustic features such as Mel-frequency cepstral coefficients from the audio, and passes these features into an acoustic model and language model that estimate the most probable token sequence corresponding to the spoken utterance. Terminal decodes the output probabilities into a character string or word sequence. The output of this step is character information representing the recognized content of the user's speech, for example the string “Does this product come in other colors?”.

Step 4:

Terminal prepares and sends request data to the server.

Terminal aggregates either the recognized character information from speech or the directly typed character information into a request object. The input is the character string provided by the user and context metadata such as current language, application mode, and device type. Terminal constructs a structured data object (such as a JSON object) that includes fields for input text, processing mode (for example, “correction”, “rewrite”, or “summary”), and user or session identifiers. Terminal then transmits this object to the server via a network interface using a secure protocol such as HTTPS over TCP/IP. The output of this step is a network request message containing the text and context, delivered to the server.

Step 5:

Server receives request and normalizes character information.

Server accepts the network request through an HTTP server component and parses the structured data. The input is the request object containing character information and associated metadata. Server extracts the text, decodes it into a uniform internal encoding such as UTF-8, and removes control characters or unsupported symbols. Server may also normalize whitespace, convert full-width and half-width characters as needed, and split the text into preliminary units by sentence boundaries. The output of this step is a clean, normalized text string stored in server memory.

Step 6:

Server tokenizes character information.

Server applies a tokenization algorithm to segment the normalized text into smaller units. The input is the normalized character string. Server uses a tokenizer module that may apply rule-based splitting on spaces and punctuation, combined with language-specific morphological analysis when appropriate. Server converts the text into a list or array of tokens, each with attributes such as token index, surface form, and part-of-speech tag where available. The data processing includes scanning the text from left to right, detecting token boundaries, and storing positions and types in an internal token structure. The output of this step is a token sequence representation of the user's text.

Step 7:

Server detects errors and omissions in tokenized character strings.

Server runs an error detection module on the token sequence. The input is the token list produced in Step 6. Server compares each token against entries in a lexical resource and computes statistics such as edit distance to known words, token frequency in a background corpus, and probability under an n-gram language model. Server calculates for each token an error score based on these measures. If a token's error score exceeds a threshold, server labels the token as a potential misspelling. Server also analyzes token transitions to detect missing function words or improbable sequences, thereby identifying possible omissions. The output of this step is an annotated token sequence in which certain tokens or positions are flagged as containing likely errors or omissions.

Step 8:

Server evaluates politeness and clarity.

Server executes a politeness and clarity evaluation module on the tokenized and annotated text. The input is the token sequence with error flags. Server maps each token to an embedding vector using a pretrained embedding matrix and feeds the embedding sequence into a trained classifier model, such as a neural network with recurrent or transformer layers. The classifier computes scores that estimate politeness level, formality, and clarity of the sentence or document. Server aggregates token-level or sentence-level scores into overall evaluation information and associates this information with the original text as metadata. The output of this step is the original token sequence plus a set of evaluation scores indicating politeness and clarity levels.

Step 9:

Server constructs a prompt sentence for correction and rewriting.

Server uses the detected errors and evaluation scores to generate a prompt sentence tailored to the user's text and the requested processing mode. The input is the normalized text, error flags, and politeness/clarity scores. Server selects a template that corresponds to correction and polite rewriting and inserts the user text into designated template placeholders. Server may adjust instructions based on the evaluation scores, for example strengthening politeness requirements when a low politeness score is detected. As a result of this data processing, server generates a full natural-language instruction such as:

“You are a writing assistant. The following text may contain spelling errors and unclear expressions. Please correct all errors and rewrite the text to be more polite and easy to understand, while preserving the original meaning. Text: ‘[user text]’.”

The output of this step is a complete prompt sentence string that encodes the correction and rewriting instructions.

Step 10:

Server analyzes long text and constructs a prompt sentence for summarization and key extraction.

Server determines whether the user's text qualifies as long character information by checking text length and structural complexity. The input is the same normalized text and its metadata. If the text exceeds a length threshold or contains multiple paragraphs, server invokes a long-text analysis module. Server uses syntactic parsing and named-entity recognition to pre-identify candidate main points, deadlines, and stakeholders. Server stores this extraction result in an internal structure, such as lists of key sentences, date expressions, and entity names. Server then constructs a summarization-oriented prompt sentence, for example: “Summarize the following content in three bullet points, and list all deadlines and involved persons or organizations. Output the result as short, clearly separated sections titled ‘Summary’, ‘Deadlines’, and ‘Stakeholders’. Content: ‘[long text]’.”

The output of this step is a summarization prompt sentence and, optionally, a pre-extraction data structure for key information.

Step 11:

Server selects and prepares input for the generative AI model.

Server determines which prompt sentence to use based on the processing mode (correction/rewriting or summarization). The input is the set of generated prompt sentences and the original text. Server assembles the final input string to the generative AI model by concatenating the chosen prompt sentence with the original text and any relevant constraint statements, such as length limits or formality requirements. Server converts this combined string into a sequence of model tokens using a tokenizer specific to the generative AI model, assigning token IDs according to the model's vocabulary. The output of this step is a tokenized prompt sequence ready to be supplied to the generative AI model.

Step 12:

Server calls the generative AI model and generates output text.

Server invokes the generative AI model interface with the tokenized prompt as input. The input is the token sequence and generation parameters such as maximum output token count, temperature, and sampling strategy. The underlying generative AI model uses a transformer architecture with multiple self-attention layers to compute contextual representations and predict the probability distribution over next tokens at each generation step. The model applies its learned weight matrices to perform matrix multiplications, non-linear activations, and attention weight calculations. Server receives the resulting output token sequence from the model and decodes it into a character string. Depending on the prompt, the output string is a correction proposal, a rewriting proposal, a summary, or a structured text including headings such as “Summary”, “Deadlines”, and “Stakeholders”. The output of this step is the generated text string produced by the generative AI model.

Step 13:

Server post-processes generated text and structures information.

Server parses the generated text to identify segments corresponding to different functions, such as main corrected text, summary bullet points, deadlines, and stakeholder lists. The input is the generated text from Step 12. Server may apply simple pattern matching for headings and separators, or use additional lightweight natural language parsing to detect dates and names. Server then maps each detected segment to an internal data structure: for example, a field for “main_text”, an array for “key_points”, and arrays for “deadlines” and “stakeholders”. Server may also perform a final spell-check on generated output using a dictionary-based module. The output of this step is a structured representation of the generated proposals and key information.

Step 14:

Server generates display control data for terminals.

Server converts the structured information into display control data that the terminal can use directly. The input is the structured representation from Step 13 combined with information about the terminal type and screen size. Server creates layout descriptors specifying which text appears in the main area and which items appear as popup displays. Server encodes properties such as font size, position, and popup timing in a machine-readable format. For example, server sets main corrected text to appear in a central text area, and sets deadlines to appear in popup boxes at the top of the display for a specified duration. The output of this step is display control data defining the visual arrangement of generated content.

Step 15:

Server updates and manages dialogue state.

Server records the interaction history into a dialogue state store. The input is the user's original text or recognized speech, the generated outputs, and the current processing mode. Server appends new entries to a dialogue history log and updates context variables such as last used style, preferred language, and last seen entities. Server uses this updated dialogue state to influence future prompt selection and generation parameters, reducing the need to reanalyze repeated context. The output of this step is an updated dialogue state data structure stored in server memory or in a database.

Step 16:

Server sends response data and display control data to the terminal.

Server packages the generated text, structured key information, and display control data into a response object. The input is the structured data and layout descriptors produced in previous steps. Server serializes this information into a network-friendly format and sends it back to the terminal via HTTPS. The response includes fields for main text, key points, deadlines, stakeholders, and visual layout properties. The output of this step is a network response message delivered to the terminal.

Step 17:

Terminal receives response and renders visual output.

Terminal accepts the server response through its network interface. The input is the response object containing text content and display control data. Terminal parses the object and interprets layout descriptors to create user interface elements using its UI framework. Terminal places the main text in a primary display area and instantiates popup components at the coordinates and with the timing specified by the control data. Terminal thus performs a mapping from abstract layout descriptors to concrete on-screen elements, drawing text using the device's graphics subsystem. The output of this step is a rendered screen in which the user sees corrected or rewritten text and, if applicable, popup displays showing key points, deadlines, and stakeholders.

Step 18:

User reads displayed information and optionally continues the interaction.

User views the main text and popup information on the display device of the terminal. The input is the visual content presented on the screen. User may decide to read aloud the suggested response in a customer interaction, accept a corrected email, or inspect deadlines and stakeholders in a summary. User may also perform further actions, such as initiating another voice input or editing the displayed text. The output of this step is a user decision or subsequent input, which may trigger a new cycle starting again from Step 1 or Step 2.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional text-processing systems that rely on rule-based parsing or simple statistical models are not able to reliably interpret long, unstructured electronic messages and transform them into a machine-usable representation that highlights key points, deadlines, and involved entities in real time. Such conventional systems typically operate on fixed templates or predefined fields, and therefore fail when the message structure, writing style, or language usage varies across users and applications. As a result, computing devices cannot consistently extract actionable information from arbitrary incoming messages, and user interfaces on terminal devices cannot present concise, structured summaries that allow users to quickly understand what needs to be done and by when.

Furthermore, in many existing architectures, a generative AI model, when used at all, is treated merely as a black-box text generator that returns free-form natural language responses. These responses often require additional manual reading by the user and ad hoc post-processing on the client side. There is no systematic mechanism for a server to programmatically control the output format of the generative AI model through precisely constructed prompt sentences, nor is there an efficient mechanism for the server to normalize extracted time expressions into standardized date-time representations and to convert identified entities into stable identifiers usable by downstream applications. Consequently, it is difficult for computing systems to integrate AI-extracted information into structured workflows, reminders, or task-management data stores.

In addition, conventional systems do not tightly integrate the end-to-end flow from: (i) automatic detection of new incoming messages at a terminal device, (ii) server-side orchestration of prompt-driven interaction with a generative AI model, (iii) transformation of the AI output into structured information, and (iv) controlled presentation of that structured information in a specialized user interface (such as a pop-up or overlay) on the terminal device. This lack of integration leads to increased network round-trips, redundant client-side logic, and inconsistent user experiences across devices and applications.

Therefore, there is a need for an improved computer-implemented technique in which a server, using a processor, programmatically constructs prompt sentences for a generative AI model, obtains analysis results in a structured or structure-inducing format, normalizes deadlines and related entities into machine-usable representations, and delivers the resulting structured information to terminal devices in a form that can drive a consistent and efficient user interface for presenting key points, deadlines, and related entities. Such a technique should improve the operation of the overall computing system by reducing client-side processing complexity, enabling automated downstream processing of the structured data, and increasing the speed and reliability with which users can comprehend and act upon incoming information.

The specific processing by the specific processing unit 290 of the data processing device 12 in Example 2 is realized by the following means.

The present invention provides a server comprising a processor configured to tokenize input information into character units or lexical units and detect notation errors or omissions in the input information, generate a prompt sentence for instructing a generative AI model to correct the detected notation errors or omissions and to improve politeness of sentence expressions and obtain a correction proposal or a rewrite proposal from the generative AI model, acquire reception information transmitted from a communication terminal, generate a prompt sentence for instructing the generative AI model to extract information relating to key points, deadlines, and related entities from content of the reception information and obtain an analysis result including the key points, the deadlines, and the related entities from the generative AI model, normalize the deadlines included in the analysis result into date-time information, format the related entities as identifiers, edit the key points, the deadlines, and the related entities as structured information in a structured data format having predetermined item names, convert the structured information into response information for transmission to a terminal device, and cause the terminal device, via the response information, to visually present the key points, the deadlines, and the related entities in a pop-up screen or an overlay screen on a display device in a mutually separated manner. This enables an improvement in the functioning of a computer system by allowing the server to programmatically control a generative AI model through specific prompt sentences, obtain analysis results in a structure-compatible form, transform unstructured message content into normalized and indexed structured data, reduce processing complexity on terminal devices, and provide users with rapid, machine-assisted understanding of incoming information through a consistent and efficient user interface.

The term “processor” refers to a hardware computation element, such as a central processing unit or an equivalent processing circuit, that executes instructions of a program to perform the operations described in the present specification.

The term “input information” refers to character data, symbol data, or other textual data supplied to the system, including but not limited to a message body, a document, or an electronic communication.

The term “tokenize” refers to processing that divides input information into smaller units, such as characters, character strings, words, or lexical units, according to predetermined rules.

The term “notation errors or omissions” refers to errors in the written form of text, including spelling mistakes, typographical errors, missing characters, missing words, or unintended extra characters.

The term “generative AI model” refers to a data processing model implemented by software on computing hardware, which uses machine learning techniques to generate or transform natural language text in response to an input, including but not limited to large-scale neural network language models.

The term “prompt sentence” refers to a sequence of characters representing an instruction or request that is provided as input to a generative AI model in order to control or guide the processing or output behavior of the generative AI model.

The term “correction proposal” refers to text generated by the generative AI model that includes one or more candidate corrections for notation errors or omissions contained in the input information.

The term “rewrite proposal” refers to text generated by the generative AI model that rewrites at least part of the input information to improve clarity, politeness, or suitability for a particular communication context while preserving original meaning to a predetermined extent.

The term “communication terminal” refers to an electronic device, such as a mobile terminal, a personal computer, or another network-connected apparatus, that can send or receive data over a communication network.

The term “reception information” refers to information that has been received at a communication terminal from an external source, including but not limited to an electronic mail message, an instant message, a notification, or a similar electronic communication.

The term “key points” refers to portions of the content of reception information that represent main ideas, important requests, or essential facts determined on the basis of semantic analysis.

The term “deadlines” refers to temporal constraints contained in the reception information, including specific dates, times, or time periods by which a task, event, or action is expected or required to occur.

The term “related entities” refers to persons, groups, organizations, systems, or other actors that are mentioned in the reception information and are associated with the key points or deadlines.

The term “analysis result” refers to data output by the generative AI model in response to a prompt sentence, the data including at least information relating to key points, deadlines, and related entities extracted from the reception information.

The term “normalize” refers to processing that converts data expressed in various human-readable forms into a standardized machine-usable representation according to predetermined rules.

The term “date-time information” refers to data representing a point in time or a time interval in a standardized format, such as a calendar date and clock time including, optionally, time zone information.

The term “identifiers” refers to values or labels that uniquely or consistently represent related entities within the system, such as normalized names, codes, or internal identifiers.

The term “structured information” refers to information organized according to a predetermined data structure, such as fields, keys, or item names, enabling programmatic access, storage, and processing.

The term “structured data format” refers to a machine-readable format in which data is organized into named items, fields, or elements, such as a key-value representation, record representation, or equivalent structure.

The term “item names” refers to names or labels used to designate fields or elements in a structured data format, such as labels corresponding to key points, deadlines, and related entities.

The term “response information” refers to data generated by the processor for transmission to a terminal device, the data including at least structured information derived from analysis of the reception information.

The term “terminal device” refers to a communication terminal or other endpoint device that receives the response information from the server and presents information to a user.

The term “communication path” refers to a logical or physical channel for transmitting data between the server and a terminal device, including wired or wireless communication networks.

The term “display device” refers to a hardware component capable of visually presenting information, such as a liquid crystal display, an organic light-emitting diode display, or an equivalent display unit.

The term “pop-up screen” refers to a graphical user interface component that appears temporarily over other displayed content to present information, typically in a window or panel that can be dismissed by user interaction.

The term “overlay screen” refers to a graphical user interface component that is rendered on top of existing screen content to display additional information while maintaining visibility or context of the underlying content.

In one embodiment, a server includes a processor, a main memory, a non-volatile storage device, and a network interface, and a terminal includes a processor, a memory, a display device, and an input interface. The server and the terminal are interconnected via a communication network such as the Internet. The server executes server-side programs on an operating system such as a server-class operating system running on general-purpose processor hardware. The terminal executes client-side programs on an operating system such as a mobile or desktop operating system running on client hardware.

The server stores, in the non-volatile storage device, a set of executable modules including: a communication control module, a prompt generation module, a generative AI interface module, an analysis post-processing module, a data-structuring module, and a response formatting module. The server further stores, in association with these modules, configuration data defining prompt templates, structured data formats, item names, and normalization rules for temporal expressions and entities.

The server uses the communication control module to receive reception information from the terminal via the network interface. The server stores the reception information in the main memory as a data structure including, for example, a message identifier, a textual body, metadata such as reception time, and an identifier of a user associated with the terminal. The server treats the textual body as input information for subsequent processing.

The server uses the prompt generation module to generate a prompt sentence based on the input information. The server applies tokenization to the input information, using a tokenization algorithm that divides the textual body into lexical units or subword units according to predetermined rules. For example, the server uses a byte-pair-encoding or unigram-based tokenizer to convert a character string into a sequence of token identifiers. The server applies this tokenization both to detect notation errors or omissions and to prepare text for interaction with a generative AI model.

The server uses a notation error detection sub-module to detect notation errors or omissions in the tokenized input information. The server compares token sequences against a lexicon and statistical language model stored in the non-volatile storage device. The server calculates a likelihood score for each token sequence, and when the likelihood falls below a threshold or a token is not present in the lexicon, the server flags that token as a candidate error. The server also detects missing tokens by examining syntactic patterns and sequence probabilities. By using token-sequence probabilities, the server performs an analysis that is different from simple spell-checking rules and that is optimized for interaction with downstream generative AI processing.

The server uses the prompt generation module to construct a prompt sentence for a generative AI model that explicitly instructs the model to correct the detected notation errors or omissions and to improve the politeness of sentence expressions. For example, the server stores and reuses prompt patterns such as the following text-form prompts:

“Please correct spelling mistakes and typographical errors in the following text, and rewrite the sentences to be more polite and formal, while preserving the original meaning.”

“Please extract the key points, deadlines, and stakeholders from the following text and return them in a structured form under the headings ‘Key points’, ‘Deadlines’, and ‘Stakeholders’.”The server concatenates the selected prompt pattern with the original message text, inserting clear delimiters such as “Text:” or “Original message:” so that the generative AI model can distinguish between instructions and data.

The server uses the generative AI interface module to interact with a generative AI model implemented as a large-scale neural network. The generative AI model can be a transformer-based language model in which the server and a remote AI inference service cooperate. The generative AI model internally includes multiple layers of self-attention blocks, feed-forward networks, and normalization layers. The server provides, to the model, tokenized representations of the prompt sentence and the message text, together with control parameters such as temperature, maximum output length, and output format hints.

The server sends the prompt sentence and associated tokens via an application programming interface to the generative AI model. The generative AI model uses a pre-trained set of parameters, including learned attention weights and feed-forward weights, to compute contextual representations of each token. During training, the generative AI model minimizes a prediction error function such as cross-entropy between predicted token distributions and ground-truth tokens, and the model parameters are updated by gradient-based optimization methods such as stochastic gradient descent or variants thereof. The server uses the trained generative AI model in an inference mode without updating these parameters during normal operation.

The server uses the generative AI interface module to specify, via the prompt sentence, that the generative AI model output should follow a specific structure. For example, the server includes instructive wording such as:

“Output the result as:

Key points:
. . .

Deadlines:
. . .

Stakeholders:
. . . ”

This use of explicit headings and bullet markers in the prompt sentence causes the generative AI model to generate an output that is regular and machine-parseable. The server thereby reduces ambiguity in the model output and simplifies downstream parsing operations, which results in an improvement in computational efficiency and error reduction during post-processing.

The server uses the analysis post-processing module to parse the output of the generative AI model. The server receives, from the generative AI interface module, an output string produced by the generative AI model. The server applies pattern-based parsing procedures to identify the sections corresponding to key points, deadlines, and related entities. For example, the server scans for headings such as “Key points:” and then treats the subsequent line items beginning with “-” as elements of a list. The server converts these elements into an internal structured data representation in which each section is mapped to a list of strings.

The server uses a temporal normalization sub-module to process deadline strings. The server applies natural-language date-time parsing rules that map expressions such as “tomorrow”, “next Monday”, or “by the end of this month” into absolute date-time values. The server uses a date-time library stored in the non-volatile storage device, together with region-specific calendar rules and the known reception time of the message, to compute normalized date-time information. The server stores these normalized values in a structured record, including fields for a standard calendar date, a clock time, and an optional time zone offset. This processing is not a simple display formatting; rather, it provides a stable machine-usable representation that enables efficient indexing, reminder scheduling, and cross-timezone alignment.

The server uses an entity normalization sub-module to process strings representing related entities. The server compares the strings against an entity dictionary and an internal identifier table. The server applies string normalization operations, such as case normalization, trimming, and removal of non-essential honorifics, and then computes similarity scores between the normalized string and entries in the identifier table. The server assigns, to each related entity, an internal identifier that is consistent across multiple messages. This conversion from free-form names to stable identifiers reduces duplication and enhances data management within the server.

The server uses the data-structuring module to combine the key points, normalized deadlines, and normalized related entities into structured information that conforms to a predetermined structured data format. For example, the server stores the structured information as a record having item names such as “key_points”, “deadlines”, and “related_entities”. Each item name is associated with a list or a structured subrecord containing normalized values. The server ensures that all dates are stored as timestamp objects, that all entities are represented by identifiers plus human-readable labels, and that key points are stored as individual clauses. This structured representation enables efficient indexing in databases, algorithmic filtering, and fast retrieval for subsequent displays or processing without re-contacting the generative AI model.

The server uses the response formatting module to convert the structured information into response information for a terminal device. The server generates a data payload including the structured fields and additional metadata such as message identifiers and processing timestamps. The server then sends the response information via the communication control module over the network interface to the terminal.

The terminal uses its processor to receive the response information via a client communication module. The terminal parses the data payload and uses a display control module to render the key points, deadlines, and related entities on the display device. The terminal presents the information in a pop-up screen or an overlay screen that appears above existing content, such as an email or messaging application. The terminal visually separates sections, for example, by headings and list items under “Key points”, “Deadlines”, and “Stakeholders” (or equivalent general headings), enabling the user to quickly understand important content without scanning the entire original message.

The terminal uses the display control module to respond to user interactions such as touches or clicks. The terminal allows the user to dismiss the overlay, open the original message, or navigate to a time-management or task-management interface that uses the normalized deadlines and related entity identifiers. Because the server has already normalized time expressions and identified entities, the terminal can, with simple operations, integrate the structured information into reminder lists or calendar entries without needing to implement its own complex parsing logic. This division of processing reduces the computational burden on the terminal and improves overall system responsiveness.

The server can, in another embodiment, use alternative prompt sentences that request additional structure or different summarization levels. For example, the server can select a prompt such as:

“Please extract the key points, deadlines, and stakeholders from this text and summarize the key points in three bullet points.” or

“Please list all explicit dates and times in this message as deadlines, and clarify which stakeholder is responsible for each deadline.”

The server can store multiple prompt patterns and select among them based on configuration or user preferences transmitted from the terminal. The server can associate each prompt pattern with a predefined parsing strategy and structured data format, thereby tightly coupling instruction to the generative AI model and subsequent server-side processing. This architecture leads to reduced parsing ambiguity and higher extraction accuracy compared to simply receiving free-form responses from the model.

The server, by centralizing these operations, improves the functioning of the overall computer system. First, the server reduces redundant analyses by caching results and reusing normalized deadlines and entity identifiers across multiple terminals or user sessions. Second, the server reduces communication load by transmitting compact structured data instead of full re-analyses or lengthy textual descriptions. Third, the server improves processing speed and accuracy by combining the generative AI model's semantic capabilities with deterministic normalization and structuring algorithms that operate on the model's output.

The server uses a generative AI model that differs from traditional rule-based systems in that the model has learned multi-dimensional semantic relationships in a high-dimensional vector space through large-scale training. The server exploits this property through carefully designed prompt sentences and structured output interpretation, rather than relying on rigid templates. The server's combination of token-based error detection, instruction-controlling prompt sentences, structured-output parsing, and normalization logic results in a technical effect: the system can convert highly variable, unstructured text into consistent, machine-usable structured information at a speed and accuracy that cannot be achieved by conventional rule sets executed directly on the server.

The server and the terminal, in cooperation, thus provide a specific improvement in computer technology. The server offloads heavy semantic processing and normalization to centralized modules adjacently integrated with the generative AI model interface. The terminal is simplified to mainly handle display and minimal interaction, leading to lower power consumption and higher responsiveness on resource-constrained devices. At the same time, the server's structured representation enables efficient indexing and retrieval in database systems, reducing the need for repeated calls to the generative AI model and thereby saving computational resources and network bandwidth.

The user interacts with the terminal to initiate optional rewriting operations. For example, when composing an outgoing message, the user can select a function that activates a prompt such as:

“Please correct spelling mistakes and typos in the following text and rewrite it to be clearer and more polite while preserving the meaning.”

The terminal transmits the draft message to the server. The server then follows the same pattern of prompt generation, model interaction, and post-processing to obtain a rewrite proposal. The server ensures that the model output is not arbitrary but is constrained by the prompt sentence to address both correction and politeness improvement. The terminal presents the original and rewritten text side by side, enabling the user to adopt or further edit the rewritten version. This operation not only automates a user task but also exploits the server's structured control over the generative AI model, thereby improving overall text quality and consistency across communications.

In other embodiments, the server can interface with different generative AI models having different internal architectures, such as models with varying numbers of transformer layers or specialized fine-tuning on communication-related corpora. The server can store configuration parameters indicating which model to use for which type of text (for example, short notifications vs. long technical reports) and can adjust prompt sentences accordingly. The server can also adapt threshold values, tokenization schemes, and normalization rules for different languages or regions, while maintaining the same high-level structured data format and item names. By doing so, the server maintains consistent downstream processing structures while optimizing model interaction for each specific use case.

The server, across its modules, thus implements more than a generic pipeline of data retrieval, analysis, and display. The server uses particular data structures for tokens, semantic sections, normalized time values, and entity identifiers, and the server applies algorithmic steps that are tailored to the behavior and structure of a transformer-based generative AI model. This synergy between prompt sentence design, neural network inference behavior, and deterministic post-processing yields measurable improvements in extraction precision, error reduction, and computational efficiency, providing technical advantages that go beyond mere automation of human reading or summarization tasks.

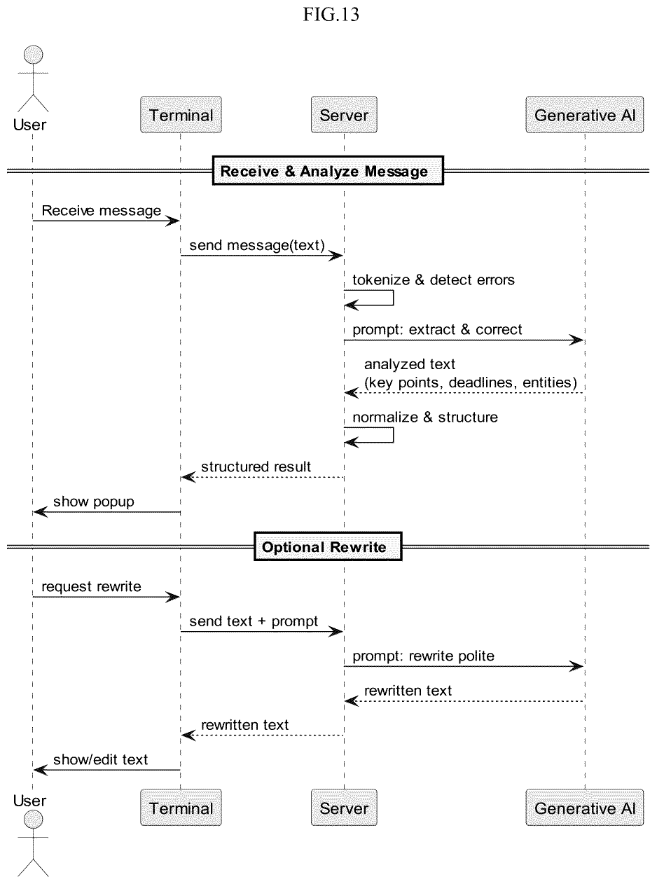

The following describes the processing flow using FIG. 13.

Step 1:

Terminal detects reception information and sends it to the server.

Terminal monitors a communication application (such as an email or messaging application) and detects that new reception information has arrived.

Input: a newly received message object including at least a textual body, a sender identifier, and a reception timestamp.

Output: a structured transmission payload sent to the server.

Terminal converts the message object into a structured payload (for example, with fields such as message_id, body_text, sender_id, and received_time) and sends this payload to the server via a network interface using a communication protocol. Terminal thereby performs data conversion from an internal application format into a network-transfer format and initiates a network transmission operation.

Step 2:

Server receives the reception information and validates it.

Server receives, through a communication control module, the payload transmitted from the terminal.

Input: the structured transmission payload containing message_id, body_text, sender_id, and received_time.

Output: a validated internal message record stored in main memory.

Server parses the received payload, verifies that mandatory fields such as body_text and message_id are present, and checks an authentication token associated with the terminal. Server discards invalid records or returns an error response if required fields are missing, and for valid records, server stores the data in an internal message record structure in main memory, thereby transforming network-level data into a normalized in-memory representation.

Step 3:

Server tokenizes the input information and detects notation errors or omissions.

Server applies a tokenization algorithm to the body_text included in the internal message record.

Input: the textual body of the reception information.

Output: a token sequence with error flags for suspected notation errors or omissions.

Server divides the text into tokens using subword or word-based tokenization rules, and then computes likelihood scores for token sequences using a stored statistical language model or lexicon. Server flags tokens whose likelihood is below a threshold or which are absent from the lexicon as candidate errors. Server records positions of these candidate errors in association with the token sequence, thereby converting raw text into a token structure annotated with potential error information.

Step 4:

Server generates a prompt sentence for correction and politeness improvement.

Server uses the detected candidate errors and the original body_text to construct a prompt sentence for a generative AI model.

Input: the original textual body and the error-annotated token sequence.

Output: a prompt sentence instructing the generative AI model to perform correction and rewriting.

Server selects a prompt pattern stored in configuration data, such as: “Please correct spelling mistakes and typographical errors in the following text, and rewrite the sentences to be more polite and formal, while preserving the original meaning.” Server concatenates this pattern with the original text, optionally marking error positions or highlighting suspicious tokens, and produces a single prompt sentence string. This string is structured so that the generative AI model can clearly distinguish instructions from the content to be processed.

Step 5:

Server invokes the generative AI model for correction and rewriting.

Server sends the generated prompt sentence to a generative AI model via a generative AI interface module.

Input: the correction and politeness-improvement prompt sentence.

Output: a correction proposal and a rewrite proposal returned by the generative AI model.

Server converts the prompt sentence into tokens compatible with the model, sets parameters such as maximum output length and temperature, and transmits the input to the generative AI model inference service. Server receives from the model an output string that contains corrected text and/or rewritten, more polite variants. Server stores this output in association with the original message record, thereby transforming an instruction-plus-text input into a machine-generated corrected output.

Step 6:

Server generates a prompt sentence for extraction of key points, deadlines, and related entities.

Server prepares a second prompt sentence to obtain structured analysis of the reception information.

Input: the original textual body (or the corrected text) and configuration of extraction items.

Output: an extraction prompt sentence specifying key points, deadlines, and related entities.

Server selects a stored prompt template such as: “Please extract the key points, deadlines, and stakeholders from the following text and return them under the headings ‘Key points’, ‘Deadlines’, and ‘Stakeholders’.” Server appends the text to be analyzed to this instruction, separated by a clear delimiter, and forms a new prompt sentence. This operation converts the internal message record into an AI-oriented instruction that encodes the desired output structure.

Step 7:

Server invokes the generative AI model for information extraction.

Server sends the extraction prompt sentence to the generative AI model to obtain analytic output.

Input: the extraction prompt sentence including the message text.

Output: an analysis result string including sections for key points, deadlines, and related entities.

Server encodes the prompt sentence into model-specific tokens and requests the generative AI model to generate an answer. Server receives an output string that contains the requested sections, for example with headings and bullet points. The server thereby transforms the textual body into a semantically organized description where important information is isolated according to the prompt constraints.

Step 8:

Server parses the analysis result and structures it into machine-usable data.

Server processes the output string from the generative AI model to extract structured elements.

Input: the analysis result string containing headings and listed items.

Output: a structured information record with fields for key points, deadlines, and related entities.

Server searches the analysis result for headings such as “Key points:”, “Deadlines:”, and “Stakeholders:” (or equivalent headings defined in configuration). Server then identifies bullet-style lines or delimited items under each heading and stores them in lists of strings associated with each heading. Server thus converts the free-form AI output into a structured record, where each category is represented as an array of text elements.

Step 9:

Server normalizes deadlines and converts related entities into identifiers.

Server refines the structured record into a normalized data structure.

Input: the structured information record with textual deadlines and textual related entities.

Output: a normalized structured record with standardized date-time information and stable entity identifiers.

Server applies a date-time parsing algorithm to each deadline string, using the reception timestamp and region-specific rules to calculate absolute calendar dates and times. Server stores these results as standardized date-time objects. Server also compares related entity strings with an internal entity table, performs string normalization (e.g., lowercasing, trimming), and assigns each related entity a unique internal identifier. Through these data operations, the server converts human-readable phrases into machine-usable temporal and entity data.

Step 10:

Server assembles final structured information and formats response information.

Server prepares a response payload for the terminal using the normalized structured record.

Input: the normalized structured record with key points, standardized deadlines, and identifier-based related entities.

Output: response information including structured fields and metadata to be sent to the terminal.

Server maps internal field names to a defined external schema, attaches message identifiers and processing timestamps, and constructs a response payload. Server then transmits this payload via the communication control module to the terminal over the network. This processing step converts internal in-memory structures into a network-transfer representation optimized for rapid parsing by the terminal.

Step 11:

Terminal receives the response information and prepares a visual presentation.

Terminal obtains the response payload from the server and processes it for display.

Input: response information containing structured key points, deadlines, and related entities.

Output: a set of user interface elements representing key points, deadlines, and related entities.

Terminal parses the structured fields, creates text labels and list items, and generates user interface components, such as headings and bullet lists, for each category. Terminal converts standardized date-time values into localized, human-readable date and time strings. This step transforms structured data into graphical elements on the display device.

Step 12:

Terminal displays a pop-up or overlay screen to the user.

Terminal renders the generated user interface elements as a transient overlay on top of the current application screen.

Input: the prepared user interface elements and layout instructions.

Output: a pop-up or overlay screen visible on the display device.

Terminal draws sections labeled, for example, “Key points”, “Deadlines”, and “Stakeholders”, and arranges the corresponding list items under each label. Terminal separates the sections visually using lines, spacing, or colors, and associates user interaction handlers such as close buttons. This step converts layout data into visible pixels, enabling the user to quickly perceive the extracted information without navigating away from the current content.

Step 13:

User reviews the presented information and optionally initiates a rewrite operation.

User observes the displayed pop-up or overlay and decides whether to accept the extracted information or request further processing.

Input: the visible key points, deadlines, and related entities on the display.

Output: a user action such as dismissing the pop-up or selecting a rewrite option.

User may tap a button such as “Proofread & Rewrite” for an outgoing message. This action generates an event that the terminal interprets as a request to send the current draft text to the server for rewriting, thereby initiating further processing based on the user's decision.

Step 14:

Terminal sends a rewriting request with a prompt sentence to the server.

Terminal constructs a second type of payload for rewriting of user-authored text.

Input: a draft message text and a user-selected or predefined prompt sentence for rewriting.

Output: a rewriting request payload transmitted to the server.

Terminal reads the current draft text from its internal storage and attaches a prompt sentence such as: “Please correct spelling mistakes and typos in the following text and rewrite it to be clearer and more polite while preserving the meaning.” Terminal sends this combination to the server as a structured payload, thereby converting local draft content and user intent into a network-level request for AI-assisted rewriting.

Step 15:

Server processes the rewriting request using the generative AI model and returns a rewrite proposal.

Server receives the rewriting payload and interacts with the generative AI model similarly to the extraction process.

Input: the draft text and the rewriting prompt sentence.

Output: a rewrite proposal text returned to the terminal.

Server tokenizes the prompt and draft text, sends them to the generative AI model with appropriate parameters, and receives an output string containing the rewritten text. Server may verify basic formatting or length constraints and then constructs a response payload including the rewritten text. The server transmits this payload back to the terminal, thus transforming the user's draft into a refined version generated under explicit instruction constraints.

Step 16:

Terminal displays the rewrite proposal and allows further user editing.

Terminal presents the original and rewritten text, or replaces the original draft with the rewritten text, based on configuration.

Input: the rewrite proposal text received from the server and the original draft text.

Output: an updated editing screen showing the improved text and enabling further user modifications.

Terminal updates its text editor component to show the rewritten content, possibly side-by-side with the original. Terminal allows the user to further edit the rewritten text using an input interface, such as a keyboard or touch-based editing. This step completes the cycle by transforming the server-generated output into an editable document that the user can finalize and send.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional text-processing systems that provide spell checking, grammar correction, and simple keyword extraction typically rely on rule-based engines or shallow machine learning models that operate in isolation from each other. As a result, such systems suffer from several technical limitations.

First, conventional systems process natural language text, user interface rendering, and emotion analysis as separate pipelines, which increases latency and computational overhead on client devices and servers. Multiple passes over the same text and redundant calls to external services cause inefficient use of processor cycles, memory, and network bandwidth. Second, existing systems generally do not automatically construct task-specific prompt sentences for a generative AI model based on the current processing context (for example, correction, politeness improvement, information extraction, or emotion-aware rewriting). Instead, they either use static templates or require manual prompt design, leading to suboptimal model outputs, unstable formats, and increased post-processing complexity. This results in additional processing on the server to normalize outputs from the generative AI model, thereby degrading throughput and response time.

Third, typical user interfaces that display analysis results present full corrected text or long summaries, rather than concise, structured elements such as key matter information, deadline information, participant information, payment due date information, amount information, and transaction counterparty information. This forces a user terminal to render and manage large text blocks, increasing the burden on the user interface layer and making it difficult to support real-time popup windows on resource-constrained devices, such as mobile terminals or head-mounted displays.

Fourth, conventional systems do not integrate emotion analysis into the core text-processing pipeline. Emotion analysis, if present at all, is often treated as an afterthought and not used to control the behavior of the generative AI model or the formatting of display output. Consequently, the system cannot adapt prompt sentences, rewriting strategies, or highlighting logic to a detected emotional state of a sender or receiver, and therefore cannot optimize the ordering, granularity, or emphasis of information presented to the user. This leads to ineffective communication support and unnecessarily repetitive or confusing user interfaces. Fifth, in many existing architectures, speech recognition is loosely coupled to downstream natural language processing and generative AI services, so that audio input is merely transcribed and then handled by generic text flows. There is no integrated, real-time pipeline that converts audio data into natural language text, immediately generates correction prompts, politeness prompts, extraction prompts, and emotion-aware prompts, and then drives a popup user interface in a time-sensitive manner. This lack of integration increases end-to-end latency, causes synchronization issues between audio and visual feedback, and limits the usability of speech-driven interfaces in high-load or time-critical environments such as industrial facilities or transaction monitoring consoles.

Accordingly, there is a need for an improved computer-implemented system in which a processor executes a unified, optimized pipeline that (i) acquires user text or speech, (ii) performs tokenization and syntactic analysis, (iii) generates context-aware prompt sentences for a generative AI model, (iv) obtains corrected and rewritten text in stable formats, (v) extracts structured information such as key matter information and transaction information, (vi) estimates emotional states and adapts processing based on those states, and (vii) generates compact display control information for popup windows. Such a system should reduce redundant computations, minimize network calls and parsing passes, provide consistent structured outputs from the generative AI model, and lower the processing burden on the user terminal, thereby improving the performance, scalability, and responsiveness of computer-based communication support.

The specific processing by the specific processing unit 290 of the data processing device 12 in Application Example 2 is realized by the following means.

The present invention provides a server comprising a processor and a memory storing instructions that, when executed by the processor, cause the processor to acquire natural language text data input or received by a user, tokenize and syntactically analyze the natural language text data using a natural language processing program, detect error information included in the natural language text data, generate a prompt sentence that instructs a generative AI model to correct the error information, obtain corrected text data from the generative AI model, generate another prompt sentence that instructs the generative AI model to generate a rewrite proposal that improves politeness and clarity of a sentence based on the corrected text data, obtain rewrite text data from the generative AI model, extract key matter information, deadline information, and participant information from at least one of the natural language text data and the corrected text data by using the natural language processing program, estimate an emotional state of a sending entity or a receiving entity for the natural language text data by using an emotion analysis program, adjust at least one of contents of the prompt sentence and the rewrite text data in accordance with the emotional state, and generate display control information for presenting at least part of the key matter information, the deadline information, the participant information, transaction information, or the rewrite text data as a popup window on a display device of a user terminal. This enables the server to implement a unified and optimized processing pipeline that reduces redundant computation and network overhead, stabilizes output formats from the generative AI model through context-aware prompt sentences, performs emotion-adaptive rewriting and information extraction in a single orchestrated flow, and delivers compact, structured display control information to the user terminal for efficient popup rendering, thereby improving the overall performance, responsiveness, and scalability of computer-based text and speech communication support.

The term “natural language text data” refers to character-based data representing human language expressions, including sentences, phrases, and words, that are processed by the system in a machine-readable format.

The term “user terminal” refers to an electronic apparatus operated by a user, such as a computing device, a portable device, or a display device, that transmits natural language text data or audio data to the server and presents output information received from the server.

The term “display device” refers to a visual output component of the user terminal, such as a screen or a head-mounted display, that is capable of presenting characters, graphics, and popup windows to a user.

The term “processor” refers to one or more hardware processing units, such as central processing units or graphics processing units, configured to execute instructions stored in a memory.

The term “memory” refers to one or more storage components, such as volatile storage or non-volatile storage, that store instructions and data for execution and processing by the processor.

The term “natural language processing program” refers to software that performs computational linguistic operations on natural language text data, including tokenization, syntactic analysis, part-of-speech tagging, named entity recognition, and related text analyses.

The term “tokenize” refers to processing natural language text data to segment the text into minimal linguistic units, such as words, subwords, or sentences, that can be independently analyzed.

The term “syntactically analyze” refers to processing natural language text data to determine grammatical relationships among tokens, including dependencies, phrase structures, and part-of-speech categories.

The term “error information” refers to information indicating textual anomalies in natural language text data, including misspellings, typographical errors, grammatical errors, and omitted characters.

The term “generative AI model” refers to a machine learning model, such as a large language model, that generates text output in response to input data and a prompt sentence, by probabilistic or neural network-based computation.

The term “prompt sentence” refers to instruction data provided to the generative AI model, including natural language text that specifies a requested operation or output format for the generative AI model.

The term “corrected text data” refers to text information output from the generative AI model that has been modified to remove or reduce error information present in the original natural language text data.

The term “rewrite proposal” refers to an alternative expression of a sentence or text segment generated by the generative AI model in accordance with a prompt sentence, for example to improve politeness, clarity, or style.

The term “rewrite text data” refers to text information output from the generative AI model as a result of a rewrite proposal, which has been transformed from the original or corrected text data to satisfy a specified stylistic or communicative requirement.

The term “key matter information” refers to information representing a main subject, task, topic, or core concept conveyed by the natural language text data.

The term “deadline information” refers to information representing a time constraint, time limit, due date, or required completion time that is described or implied in the natural language text data.

The term “participant information” refers to information representing entities involved in the content of the natural language text data, including individuals, groups, organizations, or other actors.

The term “transaction information” refers to information representing attributes of an electronic or business transaction, including payment due date information, amount information, and transaction counterparty information.

The term “payment due date information” refers to information specifying a date or time by which a payment associated with a transaction is required to be completed.

The term “amount information” refers to information specifying a quantitative value associated with a transaction, such as a monetary amount or a similar numerical measure.

The term “transaction counterparty information” refers to information identifying an entity that acts as the other side of a transaction, such as a business partner or account holder.

The term “emotion analysis program” refers to software that processes natural language text data, audio data, or other signals to estimate an emotional state, sentiment, or affective category associated with a sender or receiver.

The term “emotional state” refers to an affective condition, such as anger, joy, sadness, fear, anxiety, or neutrality, inferred from text, speech, or other user-related signals.

The term “sending entity” refers to a party associated with the generation or transmission of the natural language text data, such as a user composing a message or a system transmitting content.

The term “receiving entity” refers to a party associated with the reception or viewing of the natural language text data, such as a user reading a message or a system receiving content.

The term “adjust” refers to modify, select, reorder, emphasize, or otherwise change data, including prompt sentences and rewrite text data, based on one or more conditions, such as an estimated emotional state.

The term “display control information” refers to data specifying how information is to be presented on a display device, including layout, content selection, formatting, and triggering of popup windows.

The term “popup window” refers to a graphical user interface element that is temporarily displayed above other content on a display device to present information to a user with increased prominence.

The term “audio data” refers to time-series data representing sound signals, including speech captured from a microphone associated with a user terminal.

The term “speech recognition program” refers to software that converts audio data representing speech into natural language text data by acoustic and linguistic analysis.

In one embodiment, a server, a terminal, and a user cooperate to implement the claimed system. The server comprises at least one processor and at least one memory storing instructions that configure the processor to execute natural language processing, generative AI processing, emotion analysis, and display control generation. The terminal comprises an input interface, a display device, and a communication interface for exchanging data with the server. The user operates the terminal to input text or speech and to view popup windows generated according to the display control information.

The server runs on general-purpose computing hardware, such as a rack-mounted computer or a virtual machine instance in a data center. The server uses a central processing unit and optionally a graphics processing unit to execute software components. The server uses an operating system such as a general-purpose server operating system, and executes programs written in a high-level language such as a scripting language. The server stores natural language processing libraries, such as a tokenization and syntactic analysis library, and a large language model framework. The server also stores an emotion analysis library and a speech recognition client library for communicating with an external speech recognition service.

The server stores a generative AI model as a neural network. In one implementation, the server uses a transformer-based large language model comprising multiple self-attention layers, feed-forward sublayers, and layer normalization components. The model includes an input embedding matrix, positional encodings, multi-head attention mechanisms, and output projection layers. The server stores the model parameters in a compressed binary format. During inference, the server loads the model into memory and executes matrix multiplications and non-linear activation functions on the processor and optionally on the graphics processing unit.

In one implementation, the server uses a pre-trained transformer model that has been fine-tuned on text correction and style rewriting tasks. The model is trained using a cross-entropy loss function between the predicted token sequence and a ground truth target sequence, and the model parameters are updated by stochastic gradient descent or an adaptive optimizer. The model training uses mini-batches of tokenized sentences, and the training process includes learning rate scheduling, dropout regularization, and gradient clipping. The server may further fine-tune the model using a dataset that includes examples of polite rewriting, error correction, and structured extraction tasks, so that the model learns to respond accurately to prompt sentences used in this system.

The server uses a natural language processing program, such as a library for sentence segmentation, tokenization, part-of-speech tagging, dependency parsing, and named entity recognition. For example, the server loads a language model that has pre-defined tokenization rules and statistical parameters. The server represents text as a sequence of tokens, each associated with attributes such as lemma, part-of-speech tag, dependency relation, and entity type. The server uses these attributes to construct internal data structures, such as parse trees and entity lists.

The server uses an emotion analysis program that may be implemented as a separate neural network model. In one embodiment, the server uses a recurrent neural network or transformer encoder that takes token embeddings as input and outputs an emotion category. The model is trained on labeled data where each sentence is annotated with one or more emotion labels (for example, anger, joy, sadness, fear, or neutrality). The training uses a multi-class classification loss, such as cross-entropy, and the weights are updated by gradient-based optimization. The server uses the output probabilities to determine an emotional state, such as selecting the label with the highest probability or applying a threshold for specific emotions.

The server defines internal data structures for natural language text data, prompt sentences, model outputs, and display control information. Natural language text data is stored as a string plus a token list. Each token in the list includes character offsets, lexical form, part-of-speech, and entity type. Prompt sentences are stored as strings constructed according to templates that refer to the processing context (e.g., correction, rewriting, extraction). Model outputs are stored as strings and, in some cases, are post-processed into structured fields such as key matter information, deadline information, participant information, and transaction information. Display control information is stored as a structured object specifying popup window type, content segments, ordering, highlighting, and presentation timing.

The server generates the program modules for the system as follows. The server configures a text acquisition module to receive natural language text data from the terminal. The server configures a tokenization and syntax module to process the text data using the natural language processing library. The server configures an error detection module to examine tokens against a lexicon or statistical model to detect error information such as misspellings or improbable word sequences. The server configures a prompt construction module to generate prompt sentences for the generative AI model, according to pre-defined templates and the current processing mode.

The server configures a generative AI interface module to send prompt sentences and context text to the generative AI model and to receive corrected text data and rewrite text data. The server configures an extraction module to extract key matter information, deadline information, and participant information from the natural language text data or corrected text data using syntactic and semantic patterns. The server configures a transaction extraction module to recognize payment due date information, amount information, and transaction counterparty information from transaction-related text data, using entity recognition and context-sensitive rules. The server configures an emotion analysis module to estimate emotional states and adjust downstream processing. The server configures a display control module to generate display control information for popup windows. These modules operate with shared internal representations, so that a single parsing and tokenization pass is reused for multiple tasks, thereby reducing redundant computation and improving processing speed. The terminal runs a user interface program that communicates with the server using a network protocol. The terminal sends input data to the server, receives display control information, and renders popup windows on the display device. The terminal may implement a web-based interface using a script language and a markup language, or a native application. In one embodiment, the terminal includes an audio input device and a speech recognition client. The terminal captures audio data from the user, calls a speech recognition service through an application programming interface, receives a transcription as text, and sends this text to the server as natural language text data.

The user operates the terminal to input text, confirm suggestions, and send final messages. The user may type messages directly or use speech input. The user sees popup windows that present key matter information, deadlines, participants, transaction details, and rewriting proposals.

The server processes data as follows, without describing explicit steps. The server receives an input text from the terminal and performs tokenization and syntactic analysis using the natural language processing program. The server uses these analyses to detect error information. For instance, the server may identify a token that does not appear in a vocabulary and that has an edit distance of one from a common word. The server records this as a potential error. The server generates a prompt sentence according to a correction template, such as:

“Please correct the spelling and grammar in the following sentence: ‘Please finish assemble part A until tomorrow.’”

The server sends this prompt sentence and the embedded text to the generative AI model. The generative AI model receives the prompt sentence, converts tokens into embeddings, passes them through multiple transformer layers, and predicts a corrected token sequence. The server receives the corrected text data, such as:

“Please finish assembling part A by tomorrow.”

The server may compare the corrected text data with the original data to determine which tokens changed. This comparison allows the server to mark the modifications for later presentation.

The server generates another prompt sentence for polite and clear rewriting, such as: “Please rewrite the following sentence in more polite and clear business English: ‘Please finish assembling part A by tomorrow.’”

The server sends this prompt sentence to the generative AI model. The generative AI model re-encodes the prompt and corrected text and generates a rewritten sentence, for example: “Could you please complete the assembly of part A by tomorrow?”

The server stores this rewrite text data. The server then uses the parsed structure to extract structured information. The server examines verbs and associated objects to identify key matter information, such as “assembly of part A”. The server uses named entity recognition and pattern rules to identify phrases like “by tomorrow” as deadline information and “Mr. D” and “Ms. E” as participant information.

For transaction-related content, the server may receive text such as:

“We have received an invoice. The payment due date is next Friday, the amount is 100,000 units of currency, and the counterparty is a certain corporation.”

The server parses the text, identifies entity types “DATE,” “MONEY,” and “ORGANIZATION,” and applies rules to bind them to payment due date information, amount information, and transaction counterparty information. Alternatively, the server issues a dedicated prompt sentence to the generative AI model, such as:

“From the following message, extract payment due date, amount, and counterparty: ‘We have received an invoice. The payment due date is next Friday, the amount is 100,000 units of currency, and the counterparty is a certain corporation.’”

The generative AI model produces a structured textual answer, which the server parses back into fields. By integrating rule-based extraction with generative AI-based extraction, the server increases robustness across varied formats and writing styles.

The server applies the emotion analysis program to the natural language text data or corrected text data. The emotion analysis program converts tokens into vectors, aggregates them via attention or a recurrent structure, and outputs emotion probabilities. For example, the server may detect high probability for anger when processing:

“I am very dissatisfied with this issue.”

The server then generates an emotion-aware prompt sentence, such as:

“The following message was written in anger. Please rewrite it into a calm but firm business tone that still expresses dissatisfaction: ‘I am very dissatisfied with this issue.’”

The generative AI model produces a revised sentence, such as:

“I am concerned about this issue and would appreciate improvements.”

The server uses this process not merely to automate what a human editor would do, but to implement a consistent, emotion-sensitive transformation that systematically optimizes communication tone across multiple messages.

In some embodiments, the terminal also contributes emotion information by processing audio or image data locally. The terminal may include a camera that captures facial expressions, and a client-side neural model that classifies emotions using features such as facial landmarks and temporal motion patterns. The terminal sends emotion labels or scores to the server, which uses them to adjust prompt sentences and display control information. For example, if the terminal determines that the user appears confused, the server may include additional explanatory content in the popup, such as links to templates or definitions.

The server composes display control information from all intermediate results. The server chooses specific subsets of data to show in popup windows based on priorities and emotional context. The server organizes content into fields such as “Key matter,” “Deadline,” “Participants,” “Payment due date,” “Amount,” and “Counterparty.” The server assigns layout parameters, such as font size or highlight color, to emphasize deadlines or urgent items. The server then transmits this display control information to the terminal.

The terminal receives the display control information and renders popup windows using its user interface toolkit. For example, the terminal may display a compact popup at the top of the screen with the following content:

“Key point: assembly of part A

Deadline: tomorrow

Participants: Mr. D, Ms. E”

The terminal may also display an additional popup containing rewriting options:

“Corrected sentence: ‘Please finish assembling part A by tomorrow.’

Polite version: ‘Could you please complete the assembly of part A by tomorrow?’”

The user can accept or ignore this suggestion. If the user accepts, the terminal replaces the original message in the editing field with the polite version. The terminal therefore executes fewer local computations, because the server has already provided processed text and structured fields, which reduces local parsing and formatting overhead.

The system produces technical effects beyond mere automation of human tasks. By constructing context-specific prompt sentences and combining rule-based and neural methods, the server obtains stable, structured outputs that minimize the need for post-processing on the terminal. The server reuses a single tokenization and parsing result for multiple tasks (correction, rewriting, extraction, emotion analysis), thereby reducing the number of passes over the text data and lowering processor time and memory footprint. The server's internal data structures allow incremental updates: when small edits occur, the server can recompute only affected parts of the parse tree and extraction fields, improving throughput for large message volumes.

Moreover, the integration of emotion analysis with prompt adaptation leads to a reduction in unnecessary back-and-forth queries to the generative AI model. Without emotion-aware prompts, the server might request multiple rewrites until a suitable tone is achieved, causing additional model invocations and latency. With explicit emotion-conditioned prompts, the server drives the model to generate outputs that are closer to the desired style in a single pass, thereby improving computational efficiency and reducing network traffic to AI inference hardware.

In speech-driven scenarios, the combined pipeline from audio to popup window is optimized to support low-latency feedback. The terminal performs only the acoustic-to-text conversion using the speech recognition program and delegates the remainder of the processing to the server. By centralizing parsing, correction, rewriting, extraction, and emotion adaptation on the server, the system can leverage hardware acceleration and shared models for many users simultaneously, improving resource utilization and average response time.

The server also improves data management by unifying multiple text-processing services under a single orchestrating module. Instead of performing separate calls to independent spell-check, grammar-check, and summarization services, the server drives a single generative AI model with different prompt sentences and uses a consistent internal representation for all results. This reduces data format conversions and minimizes synchronization issues across services. As a result, the system achieves better accuracy (because different functions share the same underlying language understanding), lower error rates in extraction fields, and reduced communication overhead among internal components. In another embodiment, the server modifies the architecture of the generative AI model to better align with the extraction tasks. The server adds auxiliary output heads to the transformer network for classification of key matter, detection of deadlines, and identification of participants. These heads are trained jointly with the generation objective, using multi-task learning. The loss function includes a generation loss term and auxiliary classification loss terms. During training, the server uses gradient-based optimization to update both shared and task-specific parameters. This configuration enables the model to learn richer internal representations that support both free-form text generation and structured field prediction. At inference time, the server can query both the generated text and the auxiliary outputs, thereby reducing the need for separate extraction algorithms and shortening the data processing pipeline.

In yet another embodiment, the server uses a caching mechanism for prompt sentences and model outputs. When the server detects similar input patterns (for example, recurring templates in factory instructions or transaction notices), the server reuses previously generated prompts or even entire model outputs, after verifying that critical fields differ only in values such as dates or amounts. This reduces the number of calls to the generative AI model, decreasing computational load and network bandwidth. The caching is guided by specific string similarity measures and pattern matching rules stored in an index.

By implementing these methods, the system improves computer technology itself. The server reduces redundant parsing and modeling passes, integrates multiple high-level linguistic tasks into a shared representation, optimizes prompt sentences to achieve stable AI outputs, and designs data structures and control flows that minimize communication overhead with the terminal. These technical measures provide measurable performance benefits, such as reduced processing time per message, improved accuracy of extractions and error corrections, lower memory consumption due to shared representations, and reduced network load due to fewer model invocations and compact display control messages. The system therefore constitutes more than an abstract idea or simple automation of human intellect; it provides a concrete improvement to the functioning of computers in the domain of natural language communication support.

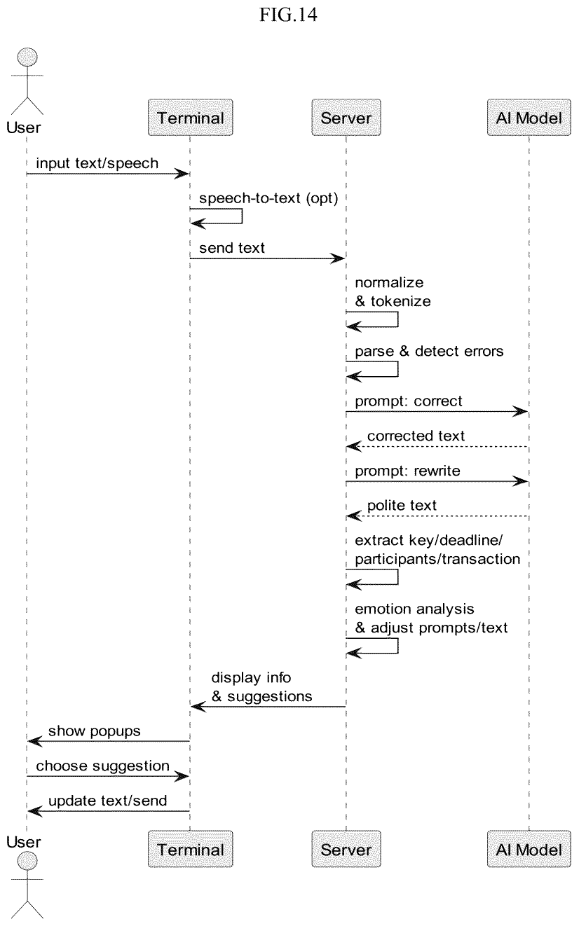

The following describes the processing flow using FIG. 14.

Step 1:

User inputs or receives content.

User enters natural language text through a keyboard, touchscreen, or speech into the terminal, or receives a message such as an email, notification, or instruction on the terminal.

Input: raw user content (typed text or audio) or received message text.

Output: raw natural language text data at the terminal.

Step 2:

Terminal prepares and sends text to the server.

Terminal, when the input is audio, converts the audio into text using a speech recognition program and attaches metadata such as message type, language, and timestamp. Terminal then packages the natural language text data and metadata into a request object and transmits it to the server over a network connection.

Input: raw natural language text data or audio data.

Data processing: optional speech-to-text conversion; encapsulation into a structured request with headers and context flags.

Output: request message containing natural language text data sent to the server.

Step 3:

Server receives and normalizes text data.

Server accepts the request from the terminal, validates required fields, and normalizes the text by converting character encoding, standardizing whitespace, and optionally converting relative dates (such as “tomorrow”) into canonical forms based on the server time.

Input: request message containing natural language text data and metadata.

Data processing: validation, character normalization, whitespace normalization, optional date normalization.

Output: normalized natural language text data stored in server memory.

Step 4:

Server tokenizes and syntactically analyzes the text.

Server uses a natural language processing program to segment the normalized text into tokens and sentences, assign part-of-speech tags, and construct dependency relations and named entity labels. Server stores a token list and parse structure for later reuse by multiple modules.

Input: normalized natural language text data.

Data processing: tokenization, part-of-speech tagging, dependency parsing, named entity recognition.

Output: internal representation including token list, parse tree, and entity list.

Step 5:

Server detects textual errors.

Server examines each token and its context using a lexicon and statistical models to detect error information such as misspellings, unlikely word sequences, or grammar inconsistencies. Server marks tokens suspected to be erroneous and compiles an error list.

Input: token list and parse structure.

Data processing: dictionary lookup, edit-distance calculation, language model scoring for anomaly detection.

Output: error information list associated with the token list.

Step 6:

Server constructs a correction prompt sentence for the generative AI model.

Server generates a prompt sentence that embeds the original text and instructs the generative AI model to correct the detected errors. For example, the server builds:

“Please correct the spelling and grammar in the following sentence: ‘Please finish assemble part A until tomorrow.’”

Input: original natural language text data and error information list.

Data processing: selection of prompt template; insertion of original text; optional inclusion of error positions or language hints.

Output: correction prompt sentence ready to be transmitted to the generative AI model.

Step 7:

Server obtains corrected text data from the generative AI model.

Server sends the correction prompt sentence to the generative AI model and receives the model's output as corrected text data. The generative AI model internally converts the prompt into embeddings, propagates them through neural network layers, and predicts a corrected token sequence; the server only handles the input and output strings.

Input: correction prompt sentence.

Data processing: remote or local model invocation; reception of generated sequence; sanity checks such as length and character set validation.

Output: corrected text data that removes or reduces error information.

Step 8:

Server constructs a politeness and clarity prompt sentence.

Server uses the corrected text data to build a second prompt sentence that instructs the generative AI model to generate a rewrite proposal that improves politeness and clarity. For example, the server builds:

“Please rewrite the following sentence in more polite and clear business English: ‘Please finish assembling part A by tomorrow.’”

Input: corrected text data.

Data processing: selection of rewriting template; insertion of corrected sentence; optional inclusion of tone or formality parameters.

Output: politeness/clarity prompt sentence for the generative AI model.

Step 9:

Server obtains rewrite text data from the generative AI model.

Server sends the politeness/clarity prompt sentence to the generative AI model and receives a rewritten sentence. The generative AI model returns, for example, “Could you please complete the assembly of part A by tomorrow?” and the server stores this as rewrite text data associated with the original message.

Input: politeness/clarity prompt sentence.

Data processing: model invocation; reception and validation of generated output; association of rewrite with original and corrected texts.

Output: rewrite text data representing a polite and clear version of the corrected text.

Step 10:

Server extracts key matter, deadline, and participant information.

Server reuses the token list, parse structure, and entity list to identify the main action and object (key matter information), time expressions (deadline information), and person or organization entities (participant information). Server may also issue a focused extraction prompt to the generative AI model, such as:

“From the following sentence, extract the key point, deadline, and stakeholders: ‘Please complete the assembly of part A by tomorrow. The persons in charge are Mr. D and Ms. E.’” and then post-process the answer into structured fields.

Input: internal representation of the text and optionally extraction prompt sentences and model outputs.

Data processing: rule-based pattern matching over parse trees; entity-type filtering; optional parsing of model-produced extraction text into key-value pairs.

Output: key matter information, deadline information, and participant information stored as structured fields.

Step 11:

Server extracts transaction-specific information when applicable.

Server checks metadata or text patterns to determine if the message is transaction-related. If so, server locates entities labeled as dates, numeric amounts, and organizations, and maps them to payment due date information, amount information, and transaction counterparty information. Alternatively, server issues a transaction-focused prompt sentence such as: “From the following message, extract payment due date, amount, and counterparty: ‘We have received an invoice. The payment due date is next Friday, the amount is 100,000 units of currency, and the counterparty is a certain corporation.’”

Input: internal representation of the text and transaction-related prompt sentences plus model responses.

Data processing: context-sensitive mapping of entity types to transaction roles; parsing of model output into structured transaction fields.

Output: transaction information fields including payment due date information, amount information, and transaction counterparty information.

Step 12:

Server analyzes emotion associated with the text.

Server applies an emotion analysis program to the natural language text data or corrected text data to estimate an emotional state of the sending entity or receiving entity. The emotion analysis program processes token embeddings and outputs probabilities for emotion categories such as anger, joy, fear, or neutrality; the server then selects the dominant emotional state.

Input: natural language text data, token embeddings, and model parameters of the emotion analysis program.

Data processing: forward pass through an emotion classification neural network; calculation of class probabilities; selection of one or more emotion labels.

Output: emotional state label and associated confidence values.

Step 13:

Server adjusts prompt sentences or rewrite text based on the emotional state.

Server uses the detected emotional state to construct emotion-aware prompt sentences or to select among multiple rewrite options. For example, when anger is detected, server constructs:

“The following message was written in anger. Please rewrite it into a calm but firm business tone that still expresses dissatisfaction: ‘I am very dissatisfied with this issue.’”

Server then obtains an emotion-aware rewrite and may choose this as the recommended version.

Input: emotional state label, original or corrected text data.

Data processing: selection of emotion-specific prompt templates; generation of prompt sentences; optional re-invocation of the generative AI model to obtain emotion-aware rewrites.

Output: updated prompt sentences and/or emotion-aware rewrite text data.

Step 14:

Server composes display control information for popup windows.

Server aggregates structured extraction fields (key matter, deadline, participants, transaction data), corrected text data, rewrite text data, and emotion-aware rewrites. Server then constructs display control information that specifies which items to show, the order of items, and highlight attributes for a popup window on the display device of the terminal.

Input: structured information fields, text variants (original, corrected, rewrite), and emotional state.

Data processing: selection and prioritization of fields; assembly of content segments; assignment of UI properties such as titles, labels, and emphasis flags.

Output: display control information object specifying popup content and layout.

Step 15:

Server transmits the processing result to the terminal.

Server sends the display control information and associated text variants to the terminal using a network response message. Server may compress the payload or encode it in a compact format to reduce network load.

Input: display control information and text variants stored at the server.

Data processing: serialization into a transmission format; optional compression and encryption; dispatch over a communication channel.

Output: response message delivered to the terminal containing all data required for rendering popups.

Step 16:

Terminal renders popup windows according to the display control information.

Terminal parses the response from the server, extracts display control information, and creates one or more popup windows on the display device. Terminal sets the content of each popup (for example, key matter, deadline, participants, or transaction fields) and arranges text according to layout instructions and emphasis flags.

Input: response message from the server and local user interface resources.

Data processing: deserialization of data; mapping of control fields to UI components; construction and rendering of popup elements on the screen.

Output: visible popup windows showing condensed information and rewrite suggestions to the user.

Step 17:

User reviews the popups and interacts with suggestions.

User reads the information shown in the popup windows, such as extracted key matter and polite rewrite sentences. User may select an action, such as accepting the polite rewrite, accepting the emotion-aware rewrite, or dismissing the popup.

Input: popup windows rendered on the display device.

Data processing (by user and terminal): user decision; user input events (clicks or taps) captured by the terminal.

Output: user commands indicating selection or rejection of specific suggestions.

Step 18:

Terminal updates the text and sends final content if requested.

Terminal, when the user accepts a suggestion, replaces the original text in the editing field with the chosen corrected or rewritten version. Terminal may then send the finalized content to a communication system, such as an email server or a messaging service, or store it locally.

Input: user commands and suggested text variants from the server.

Data processing: selection of the chosen variant; update of local text buffers; invocation of standard send or save functions.

Output: updated user message and, if sent, transmitted final content to its external destination.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

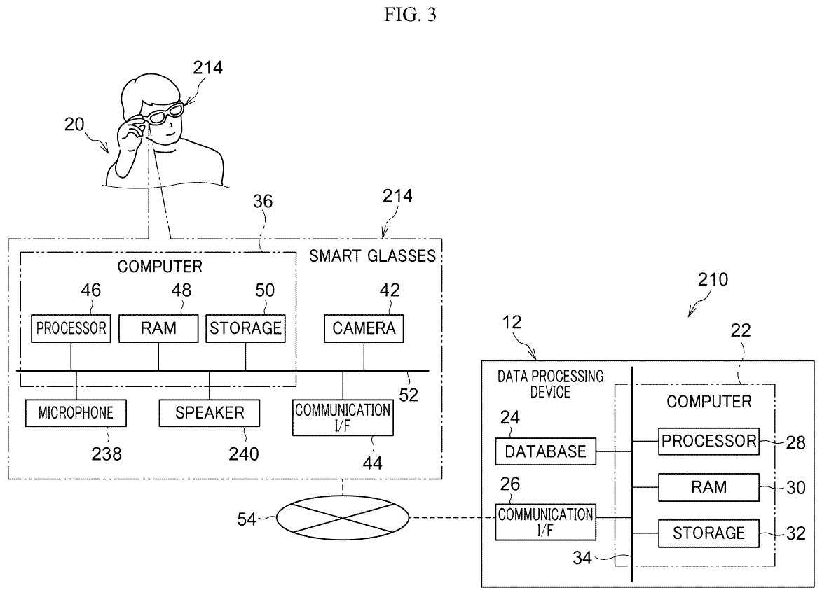

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

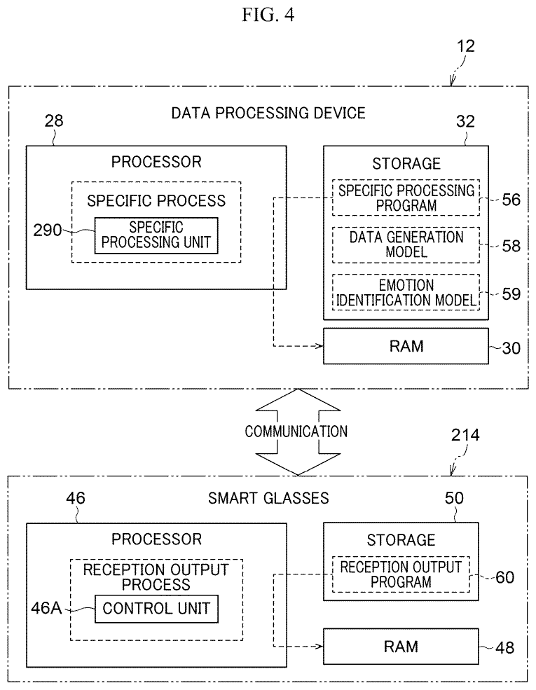

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

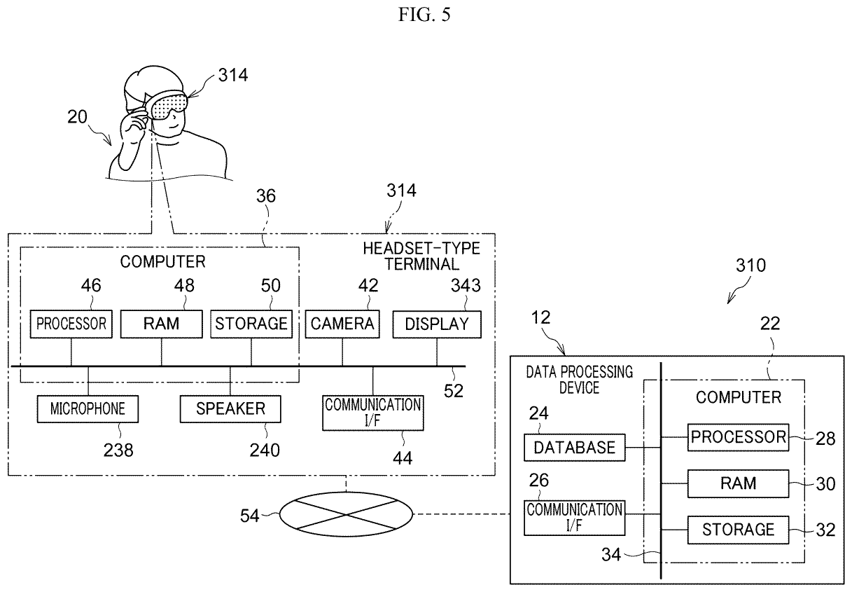

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

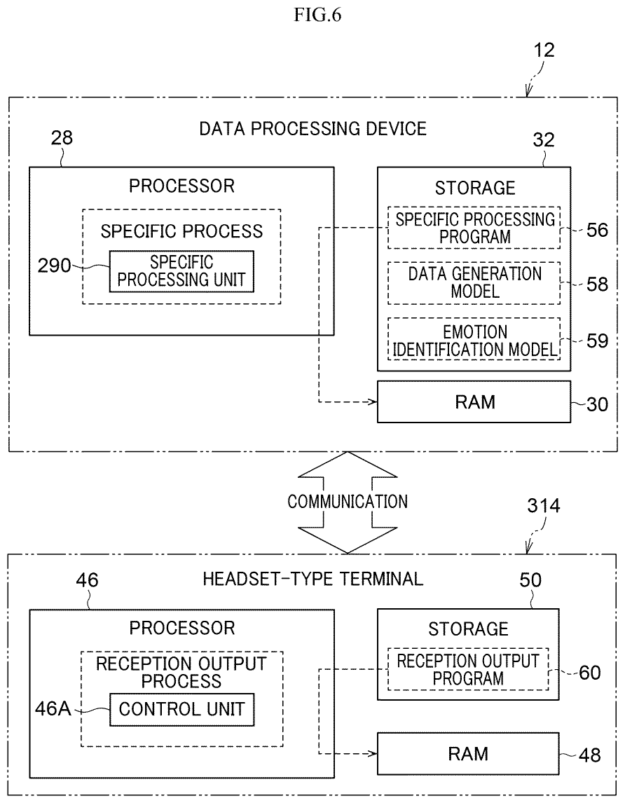

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

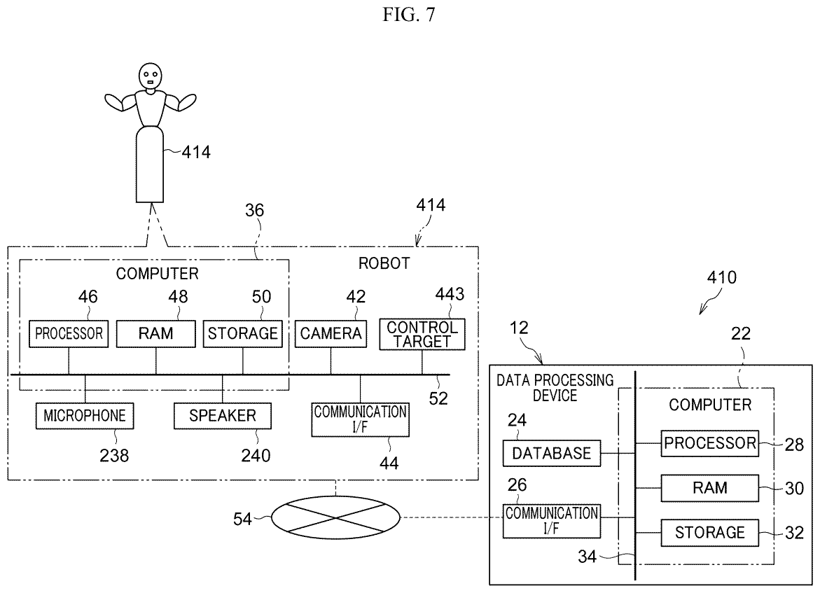

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

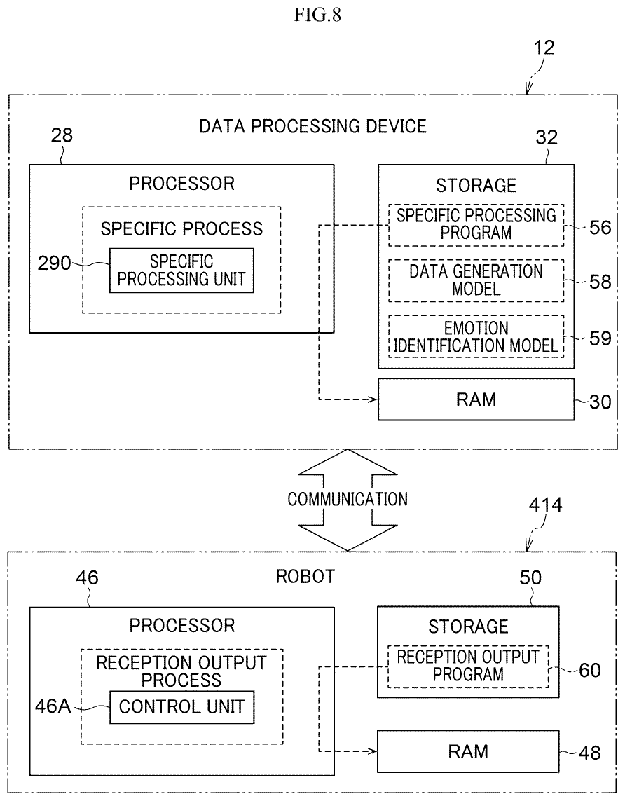

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

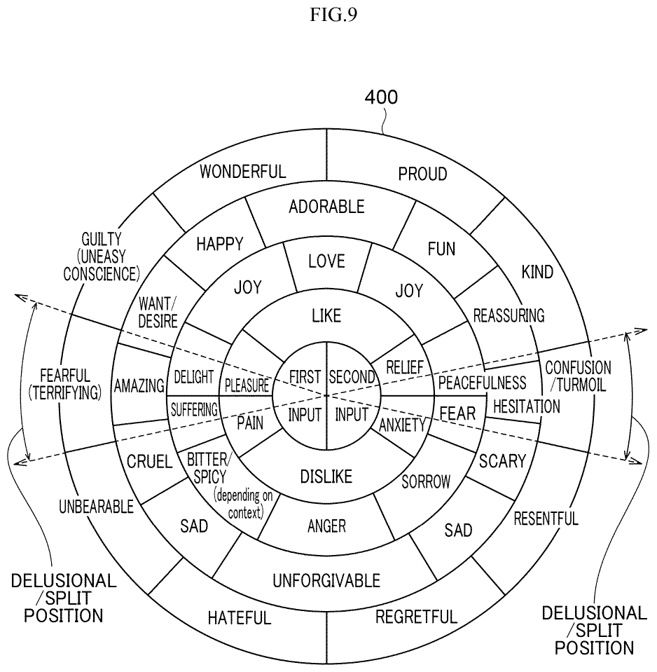

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

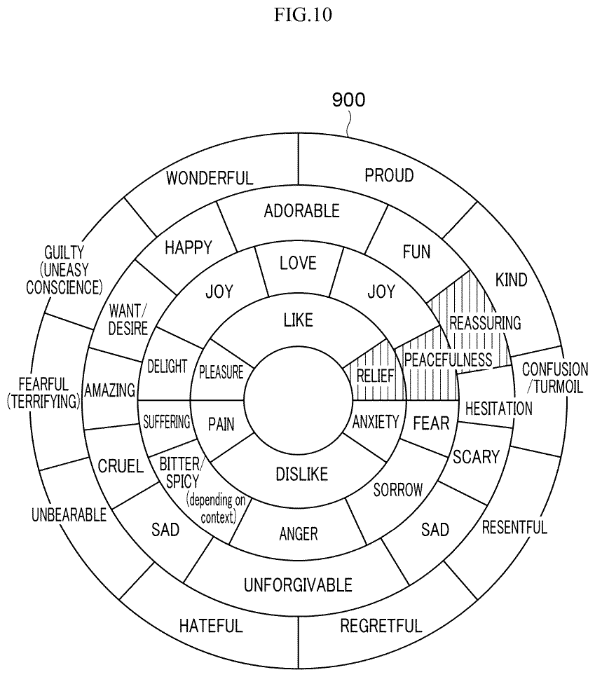

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
obtain character information input by a user via an information processing apparatus and normalize and structure the character information, and
generate, based on the structured character information and a processing type, a prompt sentence that instructs at least one of error identification, description improvement, politeness adjustment, summarization, deadline extraction, and related-entity extraction, and transmit inquiry information including the prompt sentence to a generative AI model, and
analyze response information received from the generative AI model and convert the response information into analysis result data including at least one of error locations, candidate improved sentences, candidate polite sentences, key-point information, date-and-time information, and related-entity information, and
generate output information based on the analysis result data, the output information including at least one of types of errors and correction candidates, overall improvement proposals for the text, rewrite proposals including polite expressions, summary information, candidate deadlines, and candidate related entities, and transmit the output information to a user terminal via a communication path.

### Supplementary 2

The system according to supplementary 1,
wherein the processor is configured to
control display on the user terminal so as to visually highlight the error locations included in the output information, display corresponding correction candidates and rewrite proposals in a form comparable with original character information, and receive a selection operation or re-editing operation from the user.

### Supplementary 3

The system according to supplementary 1,
wherein the processor is configured to
classify the key-point information, the date-and-time information, and the related-entity information included in the output information, and display the classified information in a list format for each category to promote understanding of information by a recipient.

### Application Example 1

### Supplementary 1

A system comprising a processor,
wherein the processor is configured to
acquire character information or voice information input by a user from a user information processing terminal, convert the voice information into character information by using a speech recognition technique, and tokenize the character information, and
detect an error or an omission in a character string in the tokenized character information and assign evaluation information relating to politeness and clarity to the character information, and
generate a prompt sentence that instructs correction of the error or the omission and rewriting for improving politeness or clarity of the character information, input the prompt sentence together with the character information into a generative artificial intelligence model, and cause the generative artificial intelligence model to generate a correction proposal or a rewriting proposal, and
analyze long character information to be viewed by a recipient, extract key point information, deadline information, and stakeholder information from the long character information, generate a prompt sentence for inputting an extraction result into the generative artificial intelligence model, and cause the generative artificial intelligence model to generate summary information and structured information, and
process the correction proposal, the rewriting proposal, the summary information, or the structured information output from the generative artificial intelligence model into display control data for presenting the correction proposal, the rewriting proposal, the summary information, or the structured information on a display device of the user information processing terminal in a display format including a popup display, and
manage a dialogue state on the basis of the character information or the voice information transmitted from the user information processing terminal and the information output from the generative artificial intelligence model, and repeatedly control processing of acquiring the character information or the voice information and processing of presenting the correction proposal, the rewriting proposal, the summary information, or the structured information.

### Supplementary 2

The system according to supplementary 1,
wherein the processor is configured to
control the user information processing terminal including an acoustic input/output device that collects the user's voice and the display device, such that the user information processing terminal visually presents, on the display device in real time, a response sentence for use in customer service interaction, based on the character information generated by the speech recognition technique and the display control data received from the system.

### Supplementary 3

The system according to supplementary 1,
wherein the processor is configured to
generate the prompt sentence to be input into the generative artificial intelligence model so as to include constraint conditions relating to style, honorific level, length, and output format of a response, and to obtain, from the generative artificial intelligence model, a response sentence, the correction proposal, the rewriting proposal, or the summary information that conforms to the constraint conditions.

### Example 2

### Supplementary 1

A system comprising a processor,
wherein the processor is configured to
tokenize input information into character units or lexical units, and detect notation errors or omissions in the input information,
generate a prompt sentence for instructing a generative AI model to correct the detected notation errors or omissions and to improve politeness of sentence expressions, and obtain a correction proposal or a rewrite proposal from the generative AI model,
acquire reception information transmitted from a communication terminal, generate a prompt sentence for instructing the generative AI model to extract information relating to key points, deadlines, and related entities from content of the reception information, and obtain an analysis result including the key points, the deadlines, and the related entities from the generative AI model,
normalize the deadlines included in the analysis result into date-time information, format the related entities as identifiers, and edit the key points, the deadlines, and the related entities as structured information, and
convert the structured information into response information for transmission to a terminal device, and transmit the response information to the terminal device via a communication path.

### Supplementary 2

The system according to supplementary 1,
wherein the processor is configured to
cause a terminal device to perform processing of acquiring the response information and visually presenting the key points, the deadlines, and the related entities in a pop-up screen or an overlay screen on a display device in a mutually separated manner.

### Supplementary 3

The system according to supplementary 1,
wherein the processor is configured to
include, in the prompt sentence, wording for instructing the generative AI model to output a summarization result, the deadlines, and the related entities in a structured data format having predetermined item names, and to analyze the analysis result in accordance with the structured data format, and acquire the key points, the deadlines, and the related entities in association with the item names.

### Application Example 2

### Supplementary 1

A system comprising a processor,
wherein the processor is configured to
acquire natural language text data input or received by a user, and tokenize and syntactically analyze the natural language text data using a natural language processing program, and detect error information included in the natural language text data, generate a prompt sentence that instructs a generative AI model to correct the error information, and obtain corrected text data from the generative AI model,
and generate another prompt sentence that instructs the generative AI model to generate a rewrite proposal that improves politeness and clarity of a sentence based on the corrected text data, and obtain rewrite text data from the generative AI model,
and extract key matter information, deadline information, and participant information from at least one of the natural language text data and the corrected text data by using the natural language processing program,
and estimate an emotional state of a sending entity or a receiving entity for the natural language text data by using an emotion analysis program, and adjust at least one of contents of the prompt sentence and the rewrite text data in accordance with the emotional state, and generate display control information for presenting at least part of the key matter information, the deadline information, the participant information, transaction information, or the rewrite text data as a popup window on a display device of a user terminal.

### Supplementary 2

The system according to supplementary 1,
wherein the processor is configured to
extract payment due date information, amount information, and transaction counterparty information from transaction-related text data by using at least one of the natural language processing program and the generative AI model, and include an extraction result in the display control information.

### Supplementary 3

The system according to supplementary 1,
wherein the processor is configured to
convert audio data acquired from a user terminal into the natural language text data by using a speech recognition program, execute in real time the processing by each of the functions defined in supplementary 1 with respect to the converted natural language text data, and control display to present an analysis result and the rewrite text data as the popup window on the user terminal.

What is claimed is:

1. A system comprising:
circuitry configured to:
receive, via a communication interface coupled to a packet-switched network, user preference data transmitted from a terminal device, construct a natural-language prompt sentence based on the user preference data, and transmit the natural-language prompt sentence to a generative neural network model to obtain structured plan data;
transmit, via the communication interface, service request data derived from the structured plan data to one or more external information processing apparatuses coupled to the packet-switched network, receive service response data from the one or more external information processing apparatuses, and associate the service response data with corresponding segments of the structured plan data;
acquire context data from at least one external data source via the packet-switched network, integrate the context data into the structured plan data, and determine whether the context data satisfies a predetermined update condition;
responsive to the context data satisfying the predetermined update condition, generate an updated natural-language prompt sentence incorporating the context data, transmit the updated natural-language prompt sentence to the generative neural network model, and modify the structured plan data based on response data received from the generative neural network model; and
generate integrated output data by combining the structured plan data, the service response data, and the context data, and transmit the integrated output data to the terminal device via the communication interface.

2. The system according to claim 1, wherein the circuitry is further configured to acquire, from a storage device, historical behavior information and preference profile information associated with an identifier of the terminal device, and incorporate the historical behavior information and the preference profile information into the natural-language prompt sentence as additional context for the generative neural network model.

3. The system according to claim 2, wherein the structured plan data comprises a data structure including a plurality of action segments, each action segment including at least a candidate location identifier, a time allocation value, and a cost allocation value, and the circuitry is configured to validate that the structured plan data conforms to a predetermined data structure format.

4. The system according to claim 3, wherein, when the structured plan data does not conform to the predetermined data structure format, the circuitry is configured to generate a regeneration prompt sentence by appending format correction instructions to the natural-language prompt sentence, transmit the regeneration prompt sentence to the generative neural network model, and receive corrected structured plan data conforming to the predetermined data structure format.

5. The system according to claim 4, wherein the candidate location identifier corresponds to an outing destination, the time allocation value corresponds to a scheduled visit duration, and the cost allocation value corresponds to an estimated expense, and the circuitry is configured to generate the natural-language prompt sentence to include user intent information reflecting at least a destination preference, a schedule constraint, a budget constraint, and an activity preference of a user.

6. The system according to claim 1, wherein the one or more external information processing apparatuses include a reservation processing apparatus, and the circuitry is configured to extract, from the structured plan data, reservation request parameters corresponding to at least one action segment, transmit the reservation request parameters to the reservation processing apparatus via the communication interface, receive candidate availability data, and store reservation confirmation data in association with the corresponding action segment of the structured plan data.

7. The system according to claim 6, wherein the reservation request parameters correspond to at least one of an accommodation facility and a transportation facility, and the circuitry is configured to present candidate availability data to the terminal device, receive a selection input from the terminal device, and confirm a reservation based on the selection input by transmitting confirmation data to the reservation processing apparatus.

8. The system according to claim 7, wherein the one or more external information processing apparatuses further include at least one of a discount information providing apparatus and a regional product information providing apparatus, and the circuitry is configured to acquire discount information or regional product information corresponding to a location or time period included in the structured plan data, and integrate the discount information or the regional product information into the integrated output data in association with the corresponding action segment.

9. The system according to claim 1, wherein the context data includes at least one of weather information acquired from a weather information providing apparatus and congestion information acquired from a traffic information providing apparatus, and the circuitry is configured to associate the weather information and the congestion information with corresponding segments of the structured plan data based on location identifiers and time values.

10. The system according to claim 9, wherein the circuitry is configured to calculate a congestion degree index based on the congestion information for each movement section included in the structured plan data, compare the congestion degree index with a predetermined congestion threshold, and, when the congestion degree index exceeds the predetermined congestion threshold, acquire alternative route information from a route search processing apparatus and update the structured plan data to include a movement route having a lower congestion degree.

11. The system according to claim 10, wherein the circuitry is configured to generate a route graph using the congestion information, apply a weighted route search algorithm to the route graph to calculate an optimal route, and coordinate with a navigation application executing on the terminal device to present the optimal route to a user in real time, wherein the circuitry adjusts route weights based on at least one of a walking section preference, a transfer count preference, and a movement comfort preference.

12. The system according to claim 1, wherein the circuitry is further configured to receive, from the terminal device, user state data comprising at least one of expression data captured by an imaging sensor, voice data captured by an audio sensor, and physiological data captured by a biometric sensor, and estimate an emotional state of a user by inputting the user state data to an emotion identification model that maps input feature vectors to emotion values on an emotion map having a valence dimension and an arousal dimension.

13. The system according to claim 12, wherein the circuitry is configured to dynamically adjust the structured plan data based on the estimated emotional state by modifying at least one of an activity content, a time allocation value, a visiting order, and a movement means included in the structured plan data, and generate the updated natural-language prompt sentence incorporating the estimated emotional state to cause the generative neural network model to regenerate modified structured plan data reflecting the emotional state.

14. The system according to claim 1, wherein the circuitry is further configured to monitor changes in the context data at predetermined time intervals, and, when a change in the context data exceeds a predetermined change threshold, automatically generate the updated natural-language prompt sentence incorporating information corresponding to the change and transmit the updated natural-language prompt sentence to the generative neural network model to regenerate the structured plan data.

15. The system according to claim 14, wherein the change in the context data includes at least one of a weather condition change and a congestion status change, and the circuitry is configured to include in the updated natural-language prompt sentence an instruction to replace outdoor activity segments with indoor activity segments or to modify a time schedule, and update the integrated output data based on the regenerated structured plan data.

16. The system according to claim 1, wherein the terminal device comprises one of a smart device, smart glasses, a headset-type terminal, or a robot, and the circuitry is configured to transmit the integrated output data in a format adapted to an output modality of the terminal device.

17. The system according to claim 16, wherein the circuitry is further configured to perform inter-application coordination with a navigation application executing on the terminal device by transmitting movement route data derived from the structured plan data to the navigation application, and receive updated position data from the terminal device to track progress along the movement route and trigger replanning when a deviation from the movement route exceeds a predetermined deviation threshold.

18. A system comprising:
circuitry configured to:
receive, via a communication interface coupled to a packet-switched network, user preference data transmitted from a terminal device, acquire historical behavior information and preference profile information from a storage device, construct a natural-language prompt sentence incorporating the user preference data, the historical behavior information, and the preference profile information, and transmit the natural-language prompt sentence to a transformer-based generative neural network model to obtain structured plan data comprising a plurality of action segments each including a candidate location identifier, a time allocation value, and a cost allocation value;
transmit, via the communication interface, reservation request parameters extracted from the structured plan data to a reservation processing apparatus coupled to the packet-switched network, receive candidate availability data, store reservation confirmation data in association with corresponding action segments of the structured plan data, and acquire at least one of weather information from a weather information providing apparatus and congestion information from a traffic information providing apparatus;
integrate the weather information and the congestion information into the structured plan data, calculate a congestion degree index for each movement section included in the structured plan data, compare the congestion degree index with a predetermined congestion threshold, and, when the congestion degree index exceeds the predetermined congestion threshold, acquire alternative route information from a route search processing apparatus and update the structured plan data;
receive user state data from the terminal device, estimate an emotional state of a user by inputting the user state data to an emotion identification model, dynamically adjust at least one of an activity content, a time allocation value, and a visiting order included in the structured plan data based on the estimated emotional state, and generate an updated natural-language prompt sentence incorporating the estimated emotional state and changed context data for the transformer-based generative neural network model;
generate integrated output data by combining the structured plan data, the reservation confirmation data, the weather information, the congestion information, the alternative route information, and the estimated emotional state, and transmit the integrated output data to the terminal device via the communication interface; and
monitor changes in the context data at predetermined time intervals, and, responsive to a change exceeding a predetermined change threshold, regenerate the structured plan data by transmitting an updated natural-language prompt sentence to the transformer-based generative neural network model and update the integrated output data.

19. The system according to claim 18, wherein the circuitry is further configured to generate a route graph using the congestion information, apply a weighted route search algorithm to the route graph to calculate an optimal movement route, adjust route weights based on the estimated emotional state and at least one of a walking section preference, a transfer count preference, and a movement comfort preference, and coordinate with a navigation application executing on the terminal device to present the optimal movement route in real time.

20. A method performed by circuitry of a server coupled to a packet-switched network via a communication interface, the method comprising:
receiving, via the communication interface, user preference data transmitted from a terminal device, constructing a natural-language prompt sentence based on the user preference data, and transmitting the natural-language prompt sentence to a generative neural network model to obtain structured plan data;
transmitting, via the communication interface, service request data derived from the structured plan data to one or more external information processing apparatuses coupled to the packet-switched network, receiving service response data from the one or more external information processing apparatuses, and associating the service response data with corresponding segments of the structured plan data;
acquiring context data from at least one external data source via the packet-switched network, integrating the context data into the structured plan data, and determining whether the context data satisfies a predetermined update condition;
responsive to the context data satisfying the predetermined update condition, generating an updated natural-language prompt sentence incorporating the context data, transmitting the updated natural-language prompt sentence to the generative neural network model, and modifying the structured plan data based on response data received from the generative neural network model; and
generating integrated output data by combining the structured plan data, the service response data, and the context data, and transmitting the integrated output data to the terminal device via the communication interface.
